(19) United States
(12) Patent Application Publication
(10) Pub. No.: US 2023/0121772 A1
(43) Pub. Date: Apr. 20, 2023

(54) OPTICAL FIBERS WITH HIGH DOPANT CONCENTRATIONS AND SEED-FREE INTERFACES AND METHODS OF MAKING THE SAME

(71) Applicant: CORNING INCORPORATED, Corning, NY (US)

(72) Inventors: Kevin Wallace Bennett, Hammondsport, NY (US); Steven Bruce Dawes, Corning, NY (US); Alexandra Lai Ching Kao Andrews Mitchell, Ithaca, NY (US); Steven Alvin Tietje, Lindley, NY (US); Matthew Artus Tuggle, Corning, NY (US)

(21) Appl. No.: 17/965,845

(22) Filed: Oct. 14, 2022

Related U.S. Application Data
(60) Provisional application No. 63/256,689, filed on Oct. 18, 2021.

(51) Int. Cl. H01S 3/067

(52) U.S. Cl. CPC H01S 3/06716; H01S 3/06733; H01S 3/094007

(57) ABSTRACT

A method of fabricating an optical fiber, the method including providing a core portion including a doped portion having greater than or equal to 1.6 wt. % of a halide dopant and eliminating seed precursor sites at an exterior surface of the core portion, the seed precursor sites forming seeds in the optical fiber, wherein the eliminating the seed precursor sites includes one or more of: (i) fabricating the core portion by densifying an exterior portion of a silica soot body prior to exposing the silica soot body to the halide dopant, and (ii) exposing the exterior surface of the core portion to a reactive etchant. The method further including forming an optical fiber preform by applying cladding material to the exterior surface of the core portion and drawing the fiber preform into the optical fiber.

This application claims the benefit of priority under 35 U.S.C. § 120 of U.S. Provisional Application Ser. No. 63/256,689 filed on Oct. 18, 2021, the content of which is relied upon and incorporated herein by reference in its entirety.

### FIELD

The present specification generally relates to optical fibers with seed-free interfaces between core portions and claddings thereof and methods for making the same.

### TECHNICAL BACKGROUND

Optical fibers generally include core portions that are surrounded by one or more claddings. To achieve waveguiding, core portions of an optical fibers are configured to have higher refractive indices than the cladding. Depending on the application for a particular optical fiber, various different dopants may be included within different components of the optical fiber to provide a suitable refractive index profile. For example, up-dopants may be incorporated within the core portions of optical fibers and/or down-dopants may be incorporated into the claddings to generate a refractive index contrast between the core portions and the claddings. Such dopants may be introduced into the core portions or claddings by exposing core and cladding preforms (e.g., silica preforms) to dopant precursor gasses at suitable pressures to obtain a desired concentration of the dopants.

Certain doping schemes introduce a number of complexities into the fiber fabrication process. For example, certain halogen doping schemes for core portions (e.g., performed by exposure of a silica preform to a halogen precursor gas at a partial pressure of greater than 100 kPa) may result in glass that is out-of-equilibrium at 100 kPa. Because the glass is out-of-equilibrium at these relatively high pressures, the dopants in the glass have propensity to diffuse into pores in the glass or adjacent to defects present at an interface between a core portion of the preform and the cladding material being applied thereto, leading to undesirable seed formation at the interface. Relatively high dopant concentrations may result in pressurized dopant precursor gasses being contained in consolidated preforms, and such pressurized dopant precursor gasses may diffuse into defects at interfaces in the optical fiber during subsequent fabrication steps (e.g., during redrawing, when the core portion and the cladding are heated to forming temperatures). Such seeding at fiber interfaces may lead to optical fibers with substantial defects and poor performance.

### SUMMARY

According to a first aspect, a method of method of fabricating an optical fiber is disclosed. The method comprising providing a core portion comprising a doped portion comprising greater than or equal to 1.6 wt. % of a halide dopant and eliminating seed precursor sites at an exterior surface of the core portion, the seed precursor sites forming seeds in the optical fiber, wherein the eliminating the seed precursor sites comprises one or more of: (i) fabricating the core portion by densifying an exterior portion of a silica soot body prior to exposing the silica soot body to the halide dopant, and (ii) exposing the exterior surface of the core portion to a reactive etchant. The method further comprising forming an optical fiber preform by applying cladding material to the exterior surface of the core portion and drawing the fiber preform into the optical fiber.

According to another aspect, a method of fabricating an optical fiber is disclosed. The method comprising fabricating a core portion from a silica soot body, wherein the fabricating the core portion comprises exposing the silica soot body to a doping precursor comprising a halide and sintering the silica soot body to form the core portion, wherein the exposure of the silica soot body to the doping precursor results in the core portion comprising greater than or equal to 1.6 wt. % of the halide. The method further comprising forming an optical fiber preform by applying cladding material to an exterior surface of the core portion and drawing the optical fiber preform into an optical fiber, wherein, after the drawing, an interface between the cladding material and the core portion is free of gas-filled pores that are filled with the halide and that have a largest dimension greater than or equal to 10 μm.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of a single mode optical fiber comprising a halide-doped core portion, according to one or more embodiments described herein;

FIG. 2 schematically depicts a cross-sectional view of a multi-core optical fiber comprising a plurality of core portions with inner claddings doped with fluorine, according to one or more embodiments described herein;

FIG. 3 schematically depicts an outside vapor deposition process for forming a silica soot body that may be used to form preforms for components of an optical fiber, according to one or more embodiments described herein;

FIG. 4 schematically depicts a silica soot body undergoing a consolidation process in a consolidation furnace, according to one or more embodiments described herein;

FIG. 5 is a flow diagram of a method of forming an optical fiber comprising a doped portion doped with at least 1.6 wt. % of a halide, according to one or more embodiments described herein;

FIG. 6 is a flow diagram of a method of eliminating seed precursor sites at an interface between preforms of core and cladding portions of an optical fiber by exposure thereof to a reactive etchant, according to one or more embodiments described herein;

FIG. 7A schematically depicts a core portion preform and a cladding portion preform being exposed to a reactive etchant gas while heated to an elevated temperature, according to one or more embodiments described herein;

FIG. 7B schematically depicts a preform assembly comprising a plurality of core portion preforms disposed in a cladding portion preform, according to one or more embodiments described herein;

FIG. 8 is a flow diagram of a method of glazing a silica soot body and doping the silica soot body after glazing, according to one or more embodiments described herein;

FIG. 9 schematically depicts a silica soot body undergoing a pre-densification process in a vertical tube furnace, according to one or more embodiments described herein;

FIG. 10 schematically depicts a draw assembly that may be used draw an optical fiber preform into an optical fiber, according to one or more embodiments described herein;

FIG. 11 schematically depicts a core portion preform inserted into a cladding portion preform for exposure thereof to a reactive etchant gas, according to one or more embodiments described herein;

FIG. 12A is an image of an optical fiber preform drawn from the core and cladding portion preforms of FIG. 11, according to one or more embodiments described herein;

FIG. 12B is an image of an optical fiber preform drawn from core and cladding portion preforms comparable to that depicted in FIG. 11 but without exposure to the reactive etchant gas, according to one or more embodiments described herein;

FIG. 13A is a consolidation and doping sequence for a glazed silica soot body, according to one or more embodiments described herein;

FIG. 13B is a plot of diameter trace results for an optical fiber drawn from an optical fiber preform formed via performance of the method described with respect to FIG. 6;

FIG. 13C is an image of an optical fiber preform including an interface between core and cladding portion preforms that is free of seeds, according to one or more embodiments described herein;

FIG. 14 is a heat map associated with a multi-zone consolidation furnace for doping a pre-glazed silica soot body, according to one or more embodiments described herein;

FIG. 15A is an x-ray computed tomography image of a silica soot body densified via the multi-zone consolidation furnace described by FIG. 14, according to one or more embodiments described herein;

FIG. 15B is a close-up view of a portion of the x-ray computed tomography image of FIG. 15A, according to one or more embodiments described herein;

FIG. 16A is a consolidation and doping sequence for a glazed silica soot body, according to one or more embodiments described herein;

FIG. 16B is a relative refractive index profile of a core portion preform consolidated using the sequence depicted in FIG. 16A, according to one or more embodiments described herein;

FIG. 17A is a consolidation and doping sequence for a glazed silica soot body, according to one or more embodiments described herein;

FIG. 17B is a relative refractive index profiles for core portion preforms consolidated using the recipe depicted in FIG. 17A using different doping pressures, according to one or more embodiments described herein;

FIG. 18 depicts diameter trace data for an optical fiber drawn from a core portion preform consolidated using the sequence depicted in FIG. 16A, according to one or more embodiments described herein; and

FIG. 19 depicts diameter trace data for an optical fiber drawn from a core portion preform consolidated using the sequence depicted in FIG. 16A, according to one or more embodiments described herein.

### DETAILED DESCRIPTION

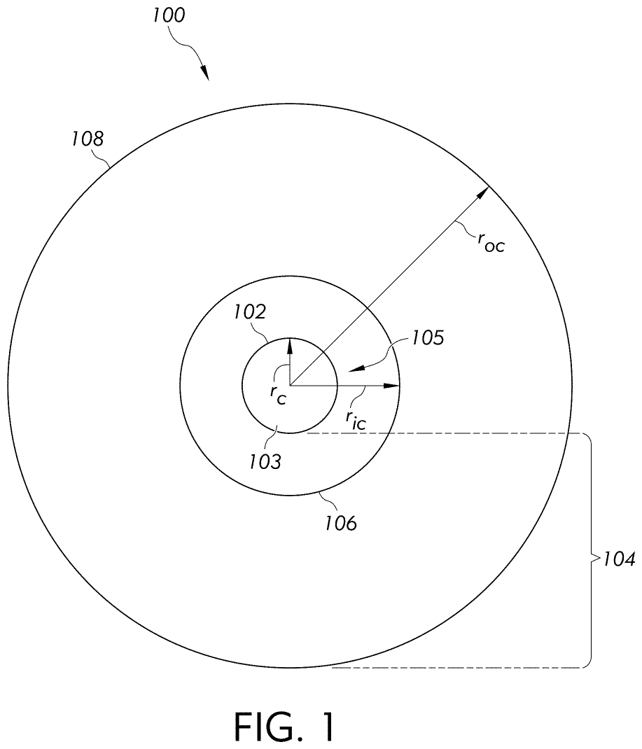

Reference will now be made in detail to embodiments of optical fibers comprising doped portions comprising greater than or equal to 1.6 wt. % of one or more halides, where the optical fibers are free of gas-filled pores with largest dimensions of greater than or equal to 10 μm at interfaces between the doped portions and other components of the optical fibers (e.g. a core or outer cladding) and methods of making the same. Whenever possible, the same reference numerals are used throughout the drawings to refer to the same or like parts. FIG. 1 schematically depicts a radial cross section of one embodiment of an optical fiber 100. While optical fiber 100 depicted in FIG. 1 is a single core, single mode optical fiber (e.g., meaning that the optical fiber 100 supports the propagation of a single mode of electromagnetic radiation above a cutoff wavelength), it should be understood that the methods of the present disclosure are not limited to such and may be applicable to other types of optical fibers. For example, as described herein, the methods described herein may be used to eliminate gas-filled pores at interfaces of multi-core optical fibers. The optical fiber structures depicted herein are only examples and it should be understood that the methods described herein are applicable to fibers have a variety of structures and compositions. The methods described herein may be applicable to, for example, reduced-clad fibers (e.g., optical fibers having diameters less than or equal to 100 μm), hydrogen resistant fibers, and radiation tolerant fibers. The methods of the present disclosure are applicable to any optical fiber that may be produced from a halide-doped preform (e.g., a soot body) containing a dopant precursor gas that may diffuse into pores and subsequently grow during the fabrication process.

As depicted in FIG. 1, the optical fiber 100 comprises a core portion 102 and a cladding portion 104. In the depicted embodiment, the core portion 102 comprises a core 103 comprising a radius r_{c}. The cladding portion 104 comprises an inner cladding 106 comprising a radius r_{ic} and an outer cladding 108 comprising a radius r_{oc}. In embodiments, the core portion 102 and the cladding portion 104 are formed from silica, specifically silica glass. In embodiments, the inner cladding 106 may be omitted. In embodiments, the inner cladding 106, when present, may surround the core portion 102 and extends from the radius r_{c} to the radius r_{ic}. The outer cladding 108 may surround the inner cladding 106 and extend from the radius r_{ic} to the radius r_{oc}. Accordingly, the glass portion of the optical fiber 100 (e.g., the core portion 102, the inner cladding 106, and the outer cladding 108) may have a diameter of 2*r_{oc}. In embodiments, the radius r_{oc} of the glass portion of the optical fiber is 62.5 microns. In embodiments described herein, the radius r_{oc} of the glass portion of the optical fiber 100 is greater than or equal to 40 microns and less than or equal to 62.5 microns

One or more components of the core portion 102 and the cladding portion 104 may be doped with one or more suitable dopants to provide a desired relative refractive index profile. For example, in embodiments, the core 103 comprises silica glass that is doped with a suitable up-dopant to provide a refractive index contrast with the inner cladding 106 to achieve effective waveguiding. In embodiments, the up-dopant comprises a suitable halide (e.g., Cl, Br). In embodiments, at least a portion of the inner cladding 106 is doped with a suitable down-dopant (e.g., F) for enhancing the refractive index contrast with the core portion 102. A relative refractive index of the core portion 102 may generally be greater than the relative refractive index profile of the cladding portion 104 to facilitate waveguiding of electromagnetic radiation propagating through the core portion 102. In embodiments, at least one of the core 103 and the inner cladding 106 comprises a doped portion that is doped with a halide (e.g., Cl, Br, F) suitable for a particular application of the optical fiber 100.

In embodiments, the optical fiber 100 comprises a single mode optical fiber and the core 103 is up-doped with one or more of Cl and Br. Such up-dopants are beneficial over other up-dopants (e.g., Ge) in that the halide dopants result in lower attenuation from Rayleigh scattering effects. The extent of the relative refractive index increase of the core 103 over pure silica achieved via halide doping may be proportional to the concentration of the halide present in the core 103 after the doping. As described herein, the concentration of the halide that is ultimately present in the core 103 may be proportional to the partial pressure of a halide dopant precursor gas that is present during fabrication of the core 103. For example, it has been determined that exposure of a silica soot body to a chlorine dopant precursor gas (e.g., SiCl₄) at a partial pressure of 100 kPa may increase the relative refractive index of the core 103 by 0.15% Δ over pure silica. Such a relative refractive index of the core 103 may require doping the inner cladding 106 with a suitable down-dopant to provide favorable bend loss performance, for example. To limit the amount of down-doping of the inner cladding 106, silica soot bodies may be exposed to halide dopant precursor gasses at partial pressures of greater than or equal to 200 kPa (e.g., greater than or equal to 300 kPa, greater than or equal to 400 kPa, greater than or equal to 500 kPa, greater than or equal to 600 kPa, etc., and less than or equal to 5100 kPa). Such doping pressures may lead to the core 103 comprising a halide dopant concentration that is greater than or equal to 1.6 wt. % (e.g., greater than or equal to 2.5 wt. %, greater than or equal to 2.8 wt. %, greater than or equal to 3.0 wt. %, greater than or equal to 3.1 wt. %, greater than or equal to 3.2 wt. %, greater than or equal to 3.3 wt. %, greater than or equal to 3.4 wt. %, greater than or equal to 3.5 wt. %, greater than or equal to 3.6 wt. %, or greater than or equal to 3.7 wt. %).

Exposure of silica soot bodies to such high pressures of halide doping precursor gasses may result in precursor gas being entrapped within optical fiber preforms (e.g., core canes). Specifically, certain halogen doping schemes for core portions (e.g., doping schemes performed by exposing a silica preform to a halogen precursor gas at a partial pressure of greater than 100 kPa) may result in glass that is out-of-equilibrium at the relatively high pressures of the doping scheme. Pores in the glass are at relatively low pressure compared to the surrounding glass. These pores may be present throughout the glass, but commonly occur, for example, at the interface between a precursor of the core 103 and precursor of the inner cladding 106. The reacted precursor gasses present in the glass due to the relatively high pressures of the doping scheme may diffuse into the pores. To the extent that the pressure of the precursor gas within such pores exceeds a surface tension of the surrounding glass (e.g., of the core portion 102 and the cladding portion 104) during formation of the optical fiber 100, such gas-filled pores may expand into noticeable flaws within the optical fiber 100. That is, to the extent that an interface between the precursors of the core 103 and inner cladding 106 includes pores into which halide doping precursor gasses may diffuse during fabrication of the optical fiber 100, the halide-filled pores become “seeds” in the optical fiber 100 drawn from the precursors of the core 103 and inner cladding 106. Thus, as described herein, seeds are flaws or defects that are generally present at an interface 105 between the core 103 and the inner cladding 106 and comprise a halide-filled pore. As discussed further below, the seeds have a size of about 0.1 μm or greater. The seeds may be detectable themselves or as diameter upsets in the optical fiber. For example, as a result of seeds between precursors of the core 103 and the inner cladding 106, substantial deviations in the diameter of the optical fiber 100 may be observed (e.g., where the diameter varies by more than 2% of an average value of the optical fiber 100).

When a sufficient number of seeds are present throughout the optical fiber 100, dimensional inconsistencies (e.g. in terms of one of the radii r_{ic} and r_{oc}) may result. Such dimensional inconsistencies may impact optical performance and, as a result, conventional fiber fabrication processes may be incapable of generating fiber of commercially viable lengths (e.g., greater than or equal to 2 km, greater than or equal to 5 km). That is, the high pressure doping of the core 103 may lead to seed formation at the interface 105 between the core 103 and the inner cladding 106 as a result of pores being initially formed at the interface between precursors of the core 103 and inner cladding 106. The methods of the present disclosure eliminate such pores from being formed between the precursors of the core portion 102 and the cladding portion 104 to prevent the formation of seeds at the interface 105, resulting in optical fiber in which the diameter varies from the average diameter of the optical fiber by 3% or less, or 2.5% or less, or 2% or less, or 1.75% or less, or 1.5% or less, or 1.25% or less, or 1% or less, or 0.75% or less, or 0.5% or less, or 0.25% or less, or 0%.

In accordance with the present disclosure, where the optical fiber 100 is a single mode optical fiber and the core is up-doped with a halide, the precursor of the core 103 comprises dissolved halide precursor gas after doping with the halide precursor gas at a partial pressure of greater than or equal to 100 kPa, When the precursor of the cladding portion 104 is applied to the precursor of the core 103 and subsequently heated (e.g. during re-drawing), pores at an interface therebetween provide a chemical potential sink such that the pores receive the halide precursor gas via diffusion. Such diffusion may result in the expansion of such pores when the precursors are heated, resulting in detectable defects in the optical fiber 100, especially when the pores are above a particular size (e.g., greater than or equal to 0.1 μm depending on the doping conditions) which enhances the rate of diffusion of the gas into the pores. The methods of the present disclosure may eliminate such pores and prevent such diffusion from occurring at the interface between the precursors of the core 103 and cladding portion 104.

While the preceding example describes an embodiment where up-doping the core 103 at a partial pressure above 100 kPa results in a high chemical potential diffusion source that may result in the formation of seeds, it should be understood that similar issues may arise in various different optical fibers having a number of different doping schemes. For example, in embodiments, the cladding portion 104 may be at least partially down-doped with F such that at least a portion of the cladding portion 104 comprises greater than or equal to 1.6 wt. % F (fluorine). Such a concentration of F within the cladding portion 104 may lead to seed formation from trapped F doping precursor gasses within a precursor of the cladding portion 104 (e.g., a consolidated cladding blank) diffusing into pores at an interface with a precursor of the core 103.

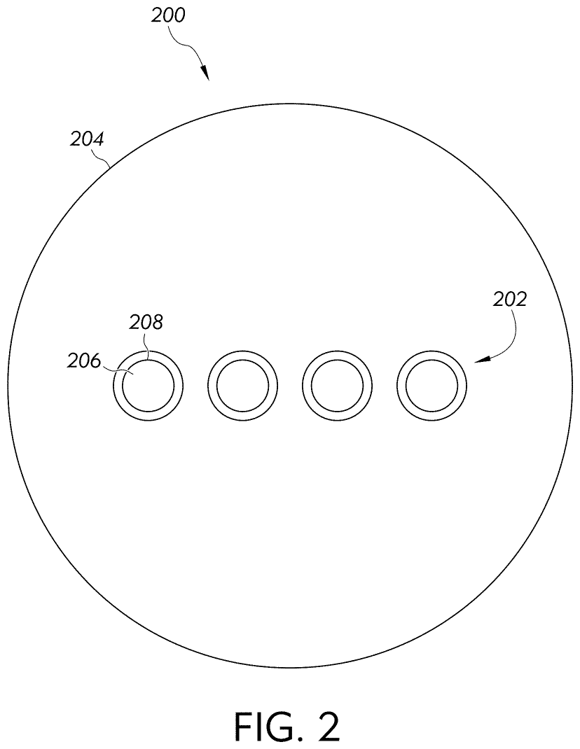

FIG. 2 schematically depicts a radial cross section of one embodiment of an optical fiber 200. The optical fiber 200 is a multi-core optical fiber comprising a plurality of core portions 202 disposed in a common cladding 204. In embodiments, each of the plurality of core portions 202 comprises a core 206 and an inner cladding 208. The plurality of core portions 202 is depicted to comprise a linear arrangement of equally-spaced cores, though the methods of the present disclosure may be applicable to multi-core fibers having different numbers of core portions that are arranged differently than in the embodiment depicted in FIG. 2.

In embodiments, the core 206 and inner cladding 208 of each of the plurality of core portions 202 may be doped with suitable up-dopants and down-dopants to facilitate favorable performance characteristics. For example, in embodiments, the inner cladding 208 of each of the plurality of core portions 202 is doped with fluorine such that at least a portion of each inner cladding 208 comprises fluorine in an amount that is greater than or equal to 1.6 wt. %. As a result, merging of precursors of each of the plurality of core portions 202 and a precursor of the common cladding 204 may result in diffusion of dopant precursor gas from the core portion precursors into pores at the interfaces between the core portion precursors and a precursor of the common cladding 204, leading to seed formation. The methods of the present disclosure may also eliminate such pores during the formation of the optical fiber 200.

The phrase “relative refractive index,” as used herein, is defined as Δ(r) %=100×(n(r)²−n_{REF}²)/2nᵢ², where nᵢ is an extrema of the refractive index in region i (i.e., the minimum or maximum of the refractive index in region i), unless otherwise specified. The relative refractive index percent is measured at 850 nm unless otherwise specified. The term n_{REF} is the refractive index of pure silica.

As used herein, the relative refractive index is represented by Δ and its values are given in units of “%,” unless otherwise specified. In cases where the refractive index of a region is less than the reference index n_{REF}, the relative refractive index is negative and is referred to as having a depressed region or depressed-index, and the minimum relative refractive index is calculated at the point at which the relative refractive index is most negative, unless otherwise specified. In cases where the refractive index of a region is greater than the reference index n_{REF}, the relative index percent is positive and the region can be said to be raised or to have a positive index.

With reference to FIGS. 1 and 2, the precursors of the core and cladding portions of the optical fibers 100 and 200 may be formed using suitable fabrication techniques. Such techniques may include flame combustion methods, flame oxidation methods, flame hydrolysis methods, OVD (outside vapor deposition), IVD (inside vapor deposition), VAD (vapor axial deposition), double crucible methods, rod-in-tube procedures, cane-in-soot methods, and doped deposited silica processes. A variety of CVD (chemical vapor deposition) and plasma-enhanced CVD processes are known and are suitable for producing silica or doped silica. Doping of silica bodies formed using such methods may occur during the formation of the silica bodies (e.g., a doping precursor gas may be introduced in conjunction with a silica precursor such as SiCl₄) and/or during or after consolidation of the silica bodies. As described herein, one or more precursors of the core portions 102, 202, and the cladding portions 104, 204 may be formed via exposure of a silica body to a halogen-containing gas to dope components of the optical fibers 100, 200 with a halide. Suitable halogen-containing gasses may include, for example, SiBr₄, Cl₂, SiCl₄, SiCl₆, Si₂OCl₆, CCl₄, F₂, CF₄, SiF₄, and combinations thereof.

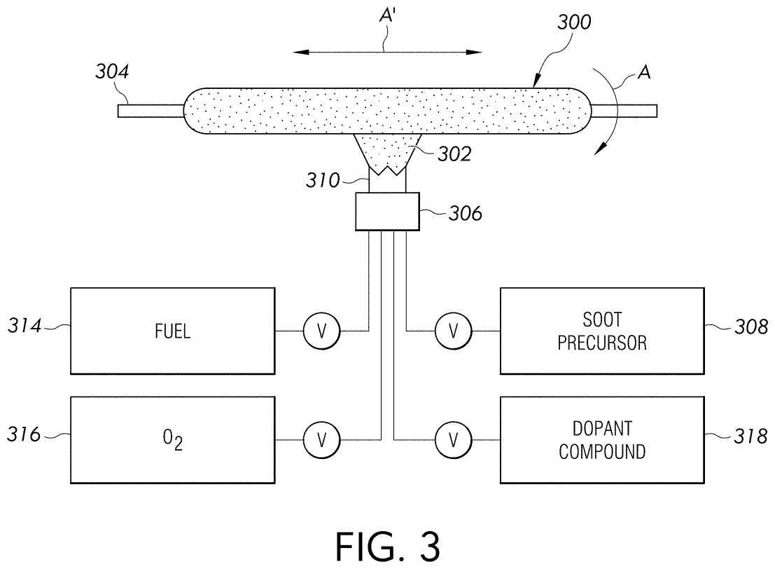

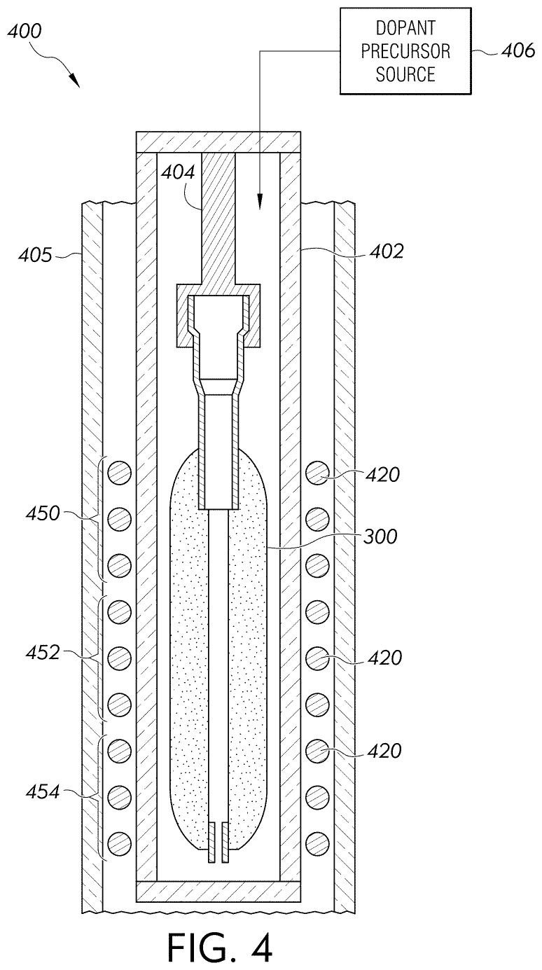

FIGS. 3 and 4 depict aspects of an OVD method that may be used to form a silica soot body 300. As depicted in FIG. 3, the silica soot body 300 is formed by depositing silica-containing soot 302 onto a bait rod 304. The silica-containing soot 302 is formed by exposing a gaseous silica soot precursor 308 to a flame 310 generated by a burner 306. The silica soot precursor 308 may be a glass former compound that forms soot particles that are deposited on the bait rod 304. The flame 310 may cause the silica soot precursor 308 to oxidize, hydrolyze, or otherwise react to form the soot particles. The flame 310 may be formed via provision of one or more of a fuel 314 and a combustion supporting gas 316 to the burner 306. The burner 306 may be moved relative to the bait rod 304 to form the silica soot body 300 comprising a substantially cylindrical-shape. In embodiments, a dopant 318 is optionally supplied to the flame 310 in conjunction with the silica soot precursor 308 via a gaseous dopant precursor 318. Mass flow controllers, labelled V, may control the concentrations and/or pressures of the various gasses supplied to the burner 306 during deposition of the silica-containing soot 302 on the bait rod 304. After formation, the bait rod 304 may be removed to form a hollow soot body. In embodiments, the silica soot body 300 may be consolidated or processed as a core portion or a cladding portion of any of the optical fibers described herein.

FIG. 4 depicts the silica soot body 300 of FIG. 3 in a consolidation furnace 400 during a consolidation step. The consolidation furnace 400 generally comprises a muffle 402 disposed within a pressure vessel 405. Heating elements 420 are disposed between the pressure vessel 405 and the muffle 402. The heating elements 420 are arranged in discrete heating zones (i.e., heating zone 450, heating zone 452, and heating zone 454) with the heating elements within each heating zone 450, 452, 454 being independently controlled. A handling structure 404 is attached to the silica soot body 300. The handling structure 404 suspends the silica soot body 300 in the muffle 402 of the consolidation furnace 400 such that the silica soot body 300 is encircled by the heating zones 450, 452, 454. In embodiments, a dopant precursor source 406 is in fluid communication with the interior of the consolidation furnace 400, specifically the interior volume of the muffle 402, to expose the silica soot body 300 to a halide-containing dopant precursor. While only a single dopant precursor source 406 is shown, embodiments are contemplated where multiple dopant precursors are in fluid communication with the consolidation furnace to facilitate doping the silica soot body 300 to more than one dopant (e.g., a combination of Cl and Br). In embodiments, a dopant concentration of the silica soot body 300 may be controlled via controlling one or more of the pressure or partial pressure of the halide-containing dopant precursor, the doping time, the number of doping cycles, and the porosity of the silica soot body 300. In embodiments, during consolidation and doping, the silica soot body 300 is heated to a temperature of greater than or equal to 1100° C., greater than 1200° C., or even greater than 1300° C. The temperature in the heating zones 450, 452, 454 may be independently controlled to directionally heat the silica soot body 300 from top to bottom, by increasing the temperature of the top zone (heating zone 450) at a faster rate than the middle zone (heating zone 452), and increasing the temperature of the middle zone (heating zone 452) at a faster rate than bottom zone (heating zone 454). In embodiments, the dopant precursor source 406 is connected to a mass flow controller to control a partial pressure of the halide-containing dopant precursor. In embodiments, the partial pressure of the halide-containing dopant precursor is greater than or equal to 100 kPa (e.g., greater than or equal to 200 kPa, greater than or equal to 300 kPa, greater than or equal to 400 kPa, greater than or equal to 500 kPa, etc.). In embodiments, the conditions of the silica soot body 300 during doping are controlled such that, after consolidation, the silica soot body 300 comprises a dopant concentration of greater than or equal to 1.6 wt. % (e.g., greater than or equal to 2.5 wt. %, greater than or equal to 2.8 wt. %, greater than or equal to 3.0 wt. %, greater than or equal to 3.1 wt. %, greater than or equal to 3.2 wt. %, greater than or equal to 3.3 wt. %, greater than or equal to 3.4 wt. %, greater than or equal to 3.5 wt. %, greater than or equal to 3.6 wt. %, or greater than or equal to 3.7 wt. %).

As described herein, such doping conditions of the silica soot body 300 may result in defects within a resultant optical fiber produced therefrom. After consolidation and doping, the silica soot body 300 may comprise halide precursor gas (e.g., at a pressure above 100 kPa within pores of the precursor). The halide precursor gas may diffuse into low chemical potential pores formed at an interface between the silica soot body 300 when another portion (e.g., a core portion or cladding portion) is contacted or otherwise applied (e.g., during re-drawing, during consolidation of a cladding soot body disposed thereon) during subsequent fabrication steps. Such diffusion may result in the expansion of such pores when the precursors are heated, resulting in detectable defects in the resultant optical fiber.

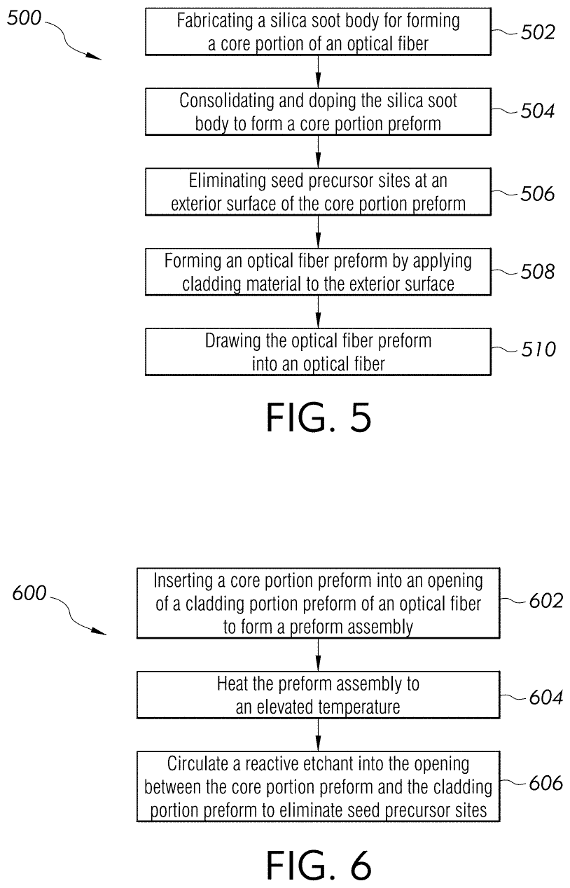

FIG. 5 depicts a flow diagram of a method 500 of fabricating an optical fiber. The method 500 may be performed to fabricate optical fibers of numerous different types (e.g., single mode, single core optical fibers, multicore optical fibers) and relative refractive index profile characteristics. In embodiments, the method 500 may be performed when a precursor of a core portion of an optical fiber being fabricated comprises a doped region (e.g., a core such as the core 103 of the optical fiber 100 described herein with respect to FIG. 1, one of the core portions 202 of the optical fiber 200 described herein with respect to FIG. 2) that is doped with a halide such that the doped portion comprises greater than or equal to 1.6 wt. % of the halide. Performance of the method 500 may effectuate a merging between the precursor of the core portion and a cladding precursor without seeds being generated at an interface between the core and cladding portion precursors.

At block 502, a silica soot body for forming a core portion of an optical fiber is provided. The silica soot body may be fabricated using any of the techniques described herein. Such techniques may include flame combustion methods, flame oxidation methods, flame hydrolysis methods, OVD (outside vapor deposition), IVD (inside vapor deposition), VAD (vapor axial deposition), double crucible methods, rod-in-tube procedures, cane-in-soot methods, and doped deposited silica processes. A variety of CVD (chemical vapor deposition) and plasma-enhanced CVD processes are known and are suitable for producing silica or doped silica. In embodiments, the OVD method described herein with respect to FIG. 3 may be used to fabricate the silica soot body 300.

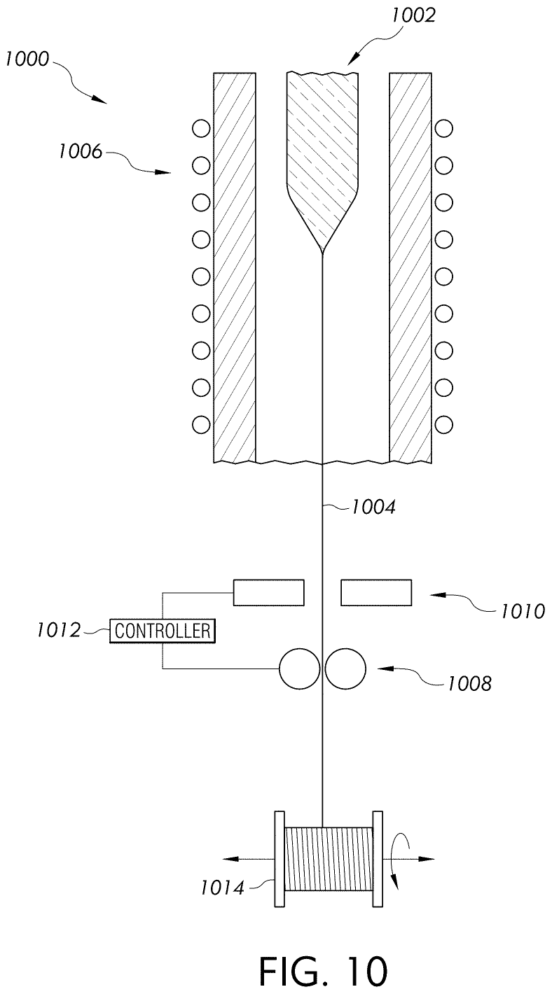

Depending on the structure of the optical fiber being fabricated, the silica soot body fabricated at block 502 may be doped (e.g., during the OVD method described herein with respect to FIG. 3 or during consolidation within the consolidation furnace 400 described herein with respect to FIG. 4) with a suitable dopant (e.g., an up-dopant such as Cl or Br), consolidated, and drawn into a core cane using a suitable draw assembly (e.g., similar to the draw assembly 1000 described herein with respect to FIG. 10). Such a core cane may then be subjected to application of additional materials (e.g., an inner cladding material) using a suitable deposition technique. For example, such a core cane may be overclad with silica soot via the OVD method in the process of forming an inner cladding thereon. In embodiments, a plurality of silica soot bodies are fabricated at block 502 to form a plurality of core portions of the optical fiber.

At block 504, the silica soot body fabricated at block 502 is consolidated and doped. In embodiments, for example, the silica soot body fabricated at block 502 is inserted into the consolidation furnace 400 described herein with respect to FIG. 4. The consolidation furnace 400 may be heated to a sintering temperature (e.g., greater than or equal to 1100° C., greater than or equal to 1300° C.) to sinter and densify the silica soot body. During consolidation, a gaseous dopant precursor (e.g., from the dopant precursor source 406) may be flowed into the consolidation furnace 400 at a partial pressure to provide a desired dopant concentration within the silica soot body. For example, in embodiments, the silica soot body may be exposed to a chlorine precursor gas (e.g., SiCl₄), a bromine precursor gas (e.g., SiBr₄), or a combination thereof at a partial pressure of greater than or equal to 100 kPa (e.g., greater than or equal to 200 kPa, greater than or equal to 300 kPa, greater than or equal to 400 kPa, greater than or equal to 500 kPa, or greater than or equal to 600 kPa, etc.) to provide a relative refractive index of the fabricated core portion that is greater than or equal to 0.25% Δ. In embodiments, the silica soot body (e.g., an overclad layer disposed on a core cane) may be exposed to a fluorine precursor (e.g., SiF₄) at a partial pressure sufficient to provide at least 1.6 wt. % F in the core portion.

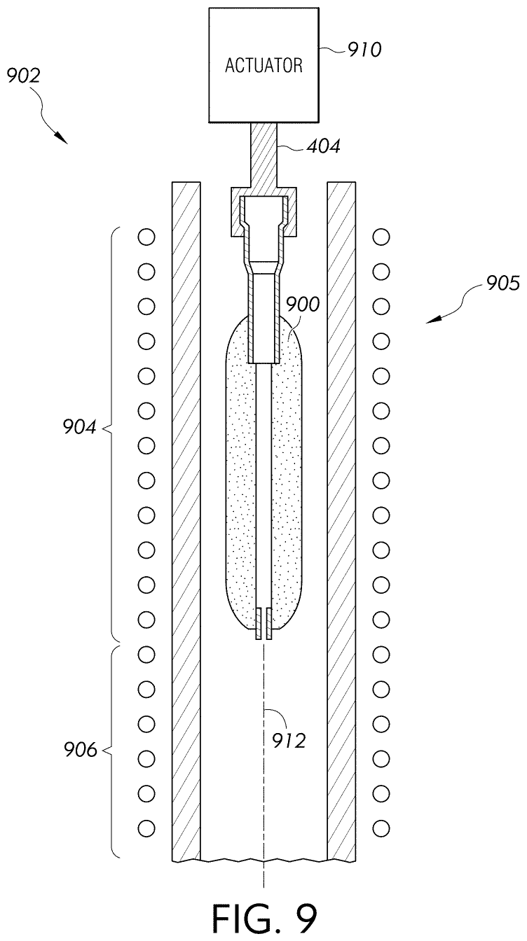

While the previous examples include doping the silica soot body during consolidation, embodiments are also envisioned where the silica soot body is at least partially consolidated prior to doping. As described herein with respect to FIGS. 8 and 9, for example, an exterior portion of the soot body may be at least partially consolidated to a density that is at least 2 times (e.g., at least 3 times) greater than an interior portion of the soot body prior to doping the soot body. As described herein, such pre-consolidation of the exterior portion of the silica soot body beneficially separates dopant precursor gasses that may become entrapped within the silica soot body and cladding precursor material that may be applied to the consolidated and doped core portion preform in subsequent fabrication steps. The separation may prevent diffusion of the dopant precursor gasses into pores at the interface between the core portion preform and the cladding portion preform.

At block 506, the method 500 includes eliminating seed precursor sites at an exterior surface of the core portion of the preform where gas-filled pores may form. As discussed above, the halide doping precursor gases may diffuse into pores (located at the exterior surface of the core portion 102) during fabrication of the preform. Such causes the pores to expand and create noticeable flaws in the drawn optical fiber. More specifically, the gas-filled pores create seeds in the drawn optical fiber. Thus, method 500 includes eliminating such seed precursor sites, which thereby reduces any seed formation in the drawn optical fiber. In particular, the seed precursor sites may provide favorable surface energy conditions that promote nucleation of gas-filled pores. Removal of the seed precursor sites reduces or eliminates the formation of the gas-filled pores, which thereby reduces the formation of seeds in the drawn optical fiber.

As used herein, a “seed precursor site” refers to a nucleation site where a pore may form or be located such that that a halide doping gas is likely to diffuse into the pore during elevated doping temperatures (e.g., about 100 kPa or greater), and therefore expand the pore, to form a seed (a gas-filled pore). As used herein, a “pore” refers to a void or bubble in an optical fiber. And, as discussed further below, the seeds have a size of about 0.1 μm or greater.

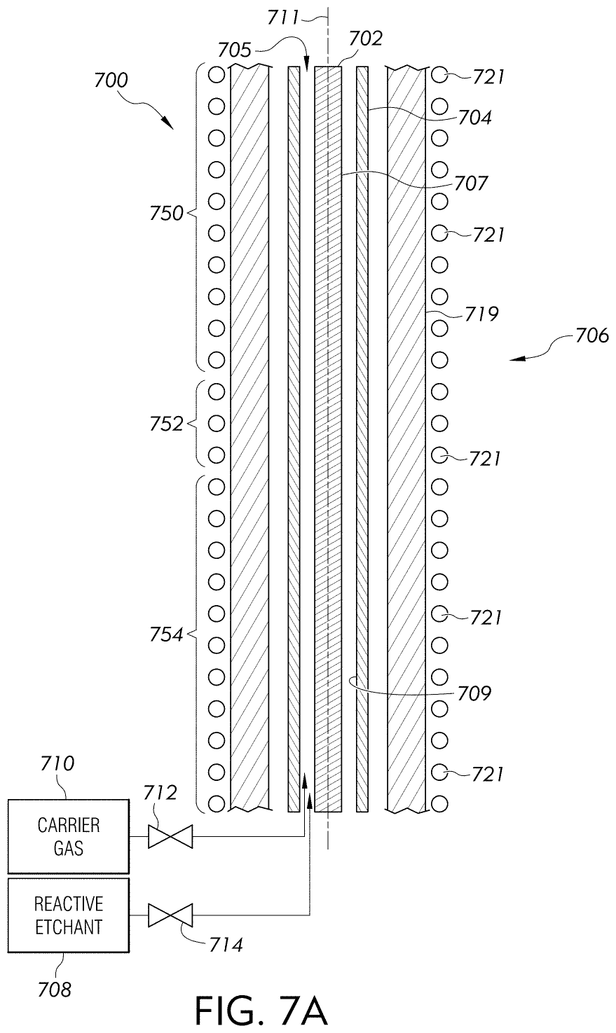

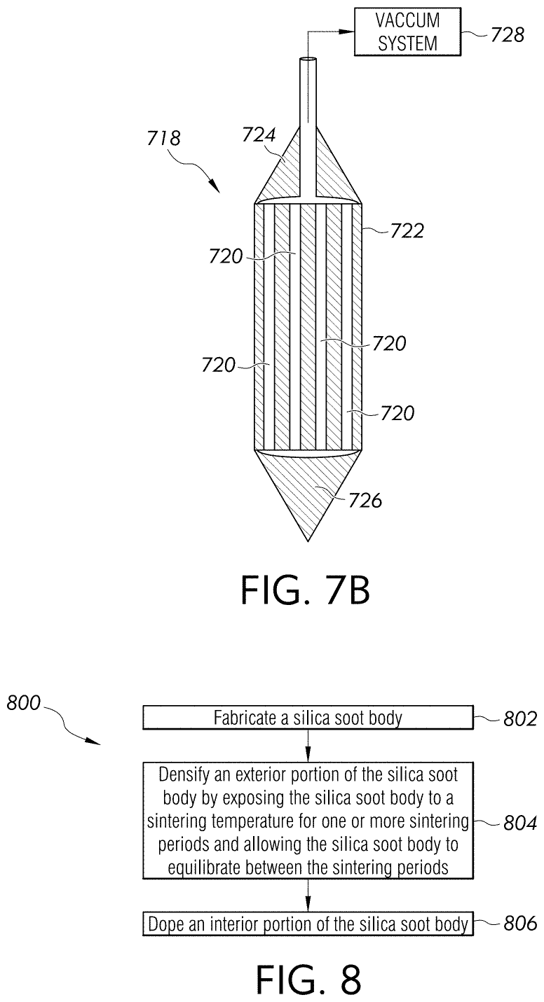

Given the presence of the dopant precursor gas within the core portion preform, seed precursor sites may be eliminated in multiple ways. In embodiments, as described herein with respect to FIGS. 6 and 7, seed precursor sites may be eliminated by preventing pore formation at an interface between the core portion preform and the cladding portion preform when the cladding portion preform is merged to the core portion preform. Such pore prevention may be performed via exposure of the core and cladding portion preforms to a reactive etchant, such as SF₆. In embodiments, the core and cladding portions are both consolidated during removal of the seed precursor sites, and the exposure to the reactive etchant may occur via providing a reactive etchant gas in an annular space extending between the core portion preform and the cladding portion preform while the preforms are heated to an elevated temperature. In embodiments, both the core portion preform and the cladding portion preform are exposed to the reactive etchant gas for more than a predetermined period such that at least 0.1 μm (e.g., at least 0.2 μm, at least 0.3 μm) of both the core portion preform and the cladding portion preform are etched. Without wishing to be bound by theory, it is believed that one or more of the reactive or etching properties of the reactive etchant gas renders the glass-on-glass merge at the interface between the core and cladding portion preforms cleaner and less susceptible to pore formation. That is, the reactive etchant removes potential pore precursor sites on either side of the interface. The absence of such pores prevents seeds from growing at the interface between the preforms.

In embodiments, the elimination of the seed precursor sites at the exterior surface of the core portion preform occurs during the consolidation of the silica soot body during the block 504. Densification of an exterior portion of the core portion preform prior to doping may effectively increase the distance between the halide and any pores contained at the interface between the core portion preform and the cladding portion preform over embodiments not including the densification. Such an increased distance may prevent diffusion of the halide into the pores at the interface, thereby preventing the pores from expanding during formation of the optical fiber. The densification of the silica soot body may occur via exposure of the silica soot body to a high temperature densification. Examples of such a process are described herein with respect to FIGS. 8 and 9.

In embodiments, the elimination of the seed precursor sites at the exterior surface of the core portion preform includes cleaning the core portion preform and/or cladding material post-consolidation. For example, in embodiments, the core portion preform may be wet using deionized water (e.g., 18 megaohm water) and ethanol alcohol, and subsequently wiped down to remove contaminates from the external surface of the core portion preform. Such contaminates may form the basis for seed formation at the interface with the cladding material and removal thereof may facilitate production of optical fibers in accordance with the methods described herein.

At block 508, after elimination of the seed precursor sites for the gas-filled pores, an optical fiber preform is formed by applying cladding material to the exterior surface of the core portion preform. As will be appreciated, the form of the cladding material may vary depending on the implementation. For example, in embodiments, the cladding material comprises a consolidated cladding blank and the cladding material may be applied to the core portion preform via a rod-in-tube method where the core portion preform is inserted into the cladding material and the cladding material is consolidated onto the core portion preform. Such a rod-in-tube technique may be used when the reactive etchant is used to eliminate the seed precursor sites for gas-filled pores at the exterior surface of the core portion pre-form.

In embodiments, a rod-in-soot technique may be used to form the optical fiber preform. For example, a silica soot body may be formed using a process similar to the OVD process described herein with respect to FIG. 3. A bait rod may be removed from the silica soot body, and the core portion preform may be introduced into the opening in the silica soot body. Consolidation of the silica soot body around the core portion preform may result in the formation of the optical fiber preform. In embodiments, silica soot may be deposited directly onto the core portion preform using an OVD deposition process. As will be appreciated, cladding material applied via any of the techniques described herein may be doped using a suitable dopant, irrespective of the form of the cladding material. For example, in embodiments, a silica soot body used to form the cladding material may be doped with fluorine and applied to a core portion preform doped with chlorine, bromine, or a combination thereof. In certain embodiments, the cladding material may not be doped or may comprise pure silica. For example, in embodiments where a multi-core optical fiber is being formed, the cladding material may comprise a consolidated multi-core cladding blank that is a fused silica ingot machined with longitudinal holes in which the plurality of core portion preforms may be inserted. In each of the preceding examples, the cladding material may be merged with the core portion preform in a consolidation furnace or re-draw furnace to form the optical fiber preform.

At block 510, the optical fiber preform is drawn into an optical fiber. In embodiments, a drawing assembly such as the draw assembly 1000 described herein with respect to FIG. 10 is used to draw the optical fiber preform into an optical fiber. The optical fiber preform (e.g., including the core portion preform formed and modified during blocks 502, 504, and 506) may be heated in a redraw furnace and pulled by a tension assembly to form an optical fiber having a suitable diameter. As described herein, during redrawing, when the optical fiber preform is heated to elevated temperatures (e.g., greater than 1600° C.) doping precursor gasses may diffuse into pores formed at the interface between the core portion preform and the cladding material applied thereto at block 508. The seed precursor site elimination performed at block 506 beneficially eliminates pores into which such dopant gas may diffuse at a high enough rate to expand the pores into detectable flaws in the drawn optical fiber. In embodiments, when the cladding material is merged into contact with the core portion preform, the interface between the cladding material and the core portion preform is free of seeds (gas-filled pores) that are greater than or equal to a critical size.

In embodiments, the critical size of the seeds is about 0.1 μm or greater. Thus, embodiments of the present disclosure prevent or reduce formation of seeds (gas-filled pores) with a size of about 0.1 μm or greater. The critical size of the seeds, as used herein, refers to the largest dimension of the seeds. For example, for a circular seed, the critical size is the diameter of the seed. For an elliptical seed, the critical size is the length of the major axis of the ellipse. It is further noted that the critical size of the seeds is inversely dependent on the partial pressure at which the core portion preform is doped during formation. For example, where the core portion preform is formed from a silica soot body doped with a suitable dopant precursor gas supplied to the silica soot body (e.g., within the consolidation furnace 400 depicted in FIG. 4) at a partial pressure of greater than or equal to 200 kPa (e.g., greater than or equal to 300 kPa, greater than or equal to 400 kPa, greater than or equal to 500 kPa, greater than or equal to 600 kPa, etc.), the critical size may be, for example and without limitation, from approximately 0.1 μm up to about 10 μm, depending on the specific pressures used during doping. In embodiments, the critical size may be from about 0.1 μm to about 9 μm, from about 0.1 μm to about 8 μm, from about 0.1 μm to about 7 μm, from about 0.1 μm to about 6 μm, from about 0.1 μm to about 5 μm, from about 0.1 μm to about 4 μm, from about 0.1 μm to about 5 μm, from about 0.1 μm to about 4 μm, from about 0.1 μm to about 3 μm, from about 0.1 μm to about 2 μm, from about 0.1 μm to about 1 μm, from about 1 μm to about 9 μm, from about 2 μm to about 8 μm, from about 3 μm to about 7 μm, or even from about 4 μm to about 6 μm, or any range formed from any of the aforementioned endpoints. In such embodiments, once the cladding material is brought into contact with the core portion preform (e.g., during consolidation of the cladding material, during redrawing of the optical fiber preform) the interface between the core portion preform and the cladding material may be free of seeds that are greater than or equal to the critical size. In some embodiments, where the partial pressure of the halide doping precursor gas is less than 200 kPa (e.g., less than or equal to 100 kPa), the critical size may be approximately 10 μm.

While the preceding example includes a single cladding material being applied to the core portion preform, it should be understood that embodiments are envisioned where additional cladding materials are applied to the optical fiber preform in the process of forming an optical fiber. For example, in embodiments, any suitable technique (e.g., rod-in-soot, rod-in-tube, OVD deposition directly on the cladding material) may be used to apply an outer cladding material to the cladding material applied to the core portion preform at block 508 to provide a suitable outer cladding layer prior to the optical fiber preform ultimately being drawn into an optical fiber.

Referring now to FIG. 6, a flow diagram of a method 600 of eliminating seed precursor sites between a core portion preform (e.g., a core cane) and a cladding portion preform (e.g., a consolidated cladding blank) during the process of forming an optical fiber is shown. The method 600 may be performed during block 506 of the method 500 described herein with respect to FIG. 5 to eliminate the formation of seeds (gas-filled pores) at an interface between the core portion preform and the cladding portion preform when the core portion preform is doped using a halide precursor gas at a partial pressure of greater than or equal to 100 kPa (e.g., greater than or equal 200 kPa, greater than or equal to 300 kPa, greater than or equal to 400 kPa, greater than or equal to 500 kPa, etc.). At block 602, a core portion preform is inserted into an opening of a cladding portion preform to form a preform assembly. The insertion of the core portion preform and the cladding portion preform may vary depending on the structure of the optical fiber. FIGS. 7A and 7B depict two different preform assemblies 700 and 718. Reference will be made to FIGS. 7A and 7B throughout the description of the method 600 to aid in the description thereof.

FIG. 7A depicts an example preform assembly 700 comprising a core portion preform 702 that is inserted into a cladding portion preform 704 to form an annular space 705 between the core portion preform and the cladding portion preform 704. The core portion preform 702 and the cladding portion preform 704 may have a variety of forms depending on the implementation. For example, in embodiments, the core portion preform comprises a consolidated and drawn silica soot body previously doped via exposure to one or more gaseous halide dopant precursors (e.g., SiCl₄, SiBr₄, SiF₄). In embodiments, for example, the core portion preform 702 is formed by forming a silica soot body via the OVD process described herein with respect to FIG. 3 and subsequently exposing the silica soot body to one or more of a Cl doping precursor gas, a Br doping precursor gas, and a combination thereof at a partial pressure of 200 kPa or more during consolidation. In embodiments, the core portion preform 702 comprises a core surrounded by an inner cladding layer doped with fluorine such that the inner cladding layer comprises at least 1.6 wt. % F. In embodiments, a handle assembly (not depicted) may be fused to the core portion preform 702 to facilitate manipulation of the preform assembly 700 and performance of the remaining steps of the method 600. The handle assembly may center the core portion preform 702 within the cladding portion preform 704 so as to form annular space 705 extending between an exterior surface 707 of the core portion preform 702 and an interior surface 709 the cladding portion preform 704.

FIG. 7B schematically depicts another preform assembly 718. The preform assembly 718 may be part of an implementation where the optical fiber being fabricated comprises a multi-core optical fiber. The preform assembly 718 comprises a plurality of core portion preforms 720 and a cladding portion preform 722. In embodiments, the plurality of core portion preforms 720 comprises cores surrounded by doped cladding layers. The doped cladding layers may be doped with fluorine so as to comprise at least 1.6 wt. % F. Such cladding layers may aid in reducing cross-talk between core portions of the multicore optical fiber that is ultimately produced. Such cross-talk reduction may be particularly useful in the production of certain multi-core fibers having core-to-core separation distances that are relatively small as compared to other multi-core optical fibers (e.g., 1×4 multi-core optical fibers). The cladding portion preform 722 comprises a multi-core blank with a fused silica ingot previously machined with holes into which the plurality of core portion preforms 720 are inserted.

Referring again to FIG. 6, at block 604, the preform assembly is heated to an elevated temperature. As depicted in FIG. 7A, for example, the preform assembly 700 may be inserted into a furnace 706 and heated to an elevated temperature. The furnace 706 may include an enclosure 719 and heating elements 721 disposed around the enclosure 719. The heating elements 721 are arranged in discrete heating zones (e.g., an etch heating zone 752 disposed between a first isothermal zone 750 and a second isothermal zone 754) with the heating elements within each zone 750, 752, 754 being independently controlled. At block 606 of FIG. 6, a reactive etchant is circulated into the opening extending between the core portion preform and the cladding portion preform. In embodiments, the reactive etchant comprises a reactive etchant gas such as SF₆. However, it should be understood that other reactive etchants are contemplated and possible including, without limitation, carbon tetrafluoride (CF₄), carbonyl fluoride (COF₂), and hydrogen fluoride (HF). For example, as depicted in FIG. 7A, the annular space 705 extending between the exterior surface 707 of the core portion preform 702 and the interior surface 709 of the cladding portion preform 704 is in fluid communication with a carrier gas source 710 and a reactive etchant source 708. Flow controllers 712 and 714 (e.g., suitable valve assemblies) may control the flow rates of the reactive etchant gas and suitable carrier gasses (e.g., He, 02, a combination thereof). In embodiments, carrier gas source 710 and reactive etchant source 708 are fluidly coupled to the annular space 705 via the handle assembly used to couple the core portion preform 702 to the cladding portion preform 704.

In embodiments, the preform assembly 700 is preheated in the furnace 706 to an equilibration temperature within the furnace 706 prior to circulating the reactive etchant into the annular space 705. In embodiments, for example, the preform assembly 700 is preheated until the preform assembly 700 equilibrates to a temperature less than or equal to 1100° C. and greater than or equal to 900° C. Thereafter, the etch heating zone 752 is heated to an etching temperature greater than or equal to 1300° C. and less than or equal to 1500° C. while the first isothermal zone 750 and the second isothermal zone 754 are held at a lower temperature, such as the equilibration temperature. The increased temperature of the etch heating zone 752 increases the rate at which the etchant gas etches the preform assembly 700 when the preform assembly is positioned in the etch heating zone 752 compared to when the preform assembly 700 is positioned in either the first isothermal zone 750 or the second isothermal zone 754, where no etching may occur due to the relatively lower temperatures. In embodiments, the preform assembly 700 is then translated with an actuator (not depicted) within the consolidation furnace prior to and/or during the circulation of the etchant gas within the annular space 705. For example, in embodiments, the preform assembly 700 is translated along a central axis 711 of the furnace 706 such that the preform assembly 700 moves through the etch heating zone 752. In embodiments, after the preform assembly 700 is preheated to the equilibration temperature, the preform assembly 700 is down driven along the central axis 711 at a first translation rate through the etch heating zone 752, and subsequently up-driven along the central axis 711 through the etch heating zone 752 at a second translation rate that is less than the first translation rate. In embodiments, the first translation rate may be in a range from about 30 mm/minute to about 100 mm/minute, such as from about 35 mm/minute to about 90 mm/minute, from about 40 mm/minute to about 80 mm/minute, from about 45 mm/minute to about 70 mm/minute, or even from about 50 mm/minute to about 60 mm/minute. In embodiments, the second translation rate may be from about 1 mm/minute to about 15 mm/minute, such as from about 1.5 mm/minute to about 13 mm/minute, from about 2 mm/minute to about 12 mm/minute, from about 3 mm/minute to about 11 mm/minute, from about 4 mm/minute to about 10 mm/minute, or even from about 5 mm/minute to about 9 mm/minute. While the preform assembly 700 is up-driven at the second translation rate, the flow controllers 712 and 714 may be open to circulate the reactive etchant gas through the annular space 705 via the carrier gas. Etching the core portion preform 702 and the cladding portion preform during up-driving may beneficially aid in uniformly exposing the exterior surface 707 and the interior surface 709 to the reactive etchant gas. However, it should be understood that the etching may be performed in the etch heating zone 752 during either the up-drive portion of the translation, the down drive portion of the translation, or both. That is the flow controller 712 and 714 may be operated to expose the preform to the etchant gas as the preform assembly is up-driven or down-driven. Etching of the preform assembly 700 may be performed in multiple steps (i.e., multiple translations through the etch heating zone 752) with the preform assembly 700 being held in an isothermal zone (either the first isothermal zone 750 or the second isothermal zone 754) between each translation.

In embodiments, the exterior surface 707 of the core portion preform 702 and the interior surface 709 of the cladding portion preform 704, along the entire length of the preform assembly 700, are exposed to the reactive etchant gas when heated to the elevated temperature for an etching period of at least 5 minutes (e.g., at least 10 minutes, at least 30 minutes) and less than about 40 minutes. The down-drive and up-drive rates may be adjusted accordingly to achieve a particular exposure time and, hence, the desired degree of etching. It has been found that exposure of the exterior surface 707 and interior surface 709 to the reactive etchant for such a period successfully eliminates seed precursor sites at an interface between the core portion preform 702 and the cladding portion preform 704. More specifically, exposure of the exterior surface 707 and the interior surface 709 to the reactive etchant eliminates pores at the interface between the core portion preform 702 and the cladding portion preform 704. This in turn eliminates the formation of seeds in the drawn optical fiber. In embodiments, exposure of the exterior surface 707 and the interior surface 709 to the reactive etchant gas for at least five minutes at the elevated etching temperature may result in both the exterior surface 707 and the interior surface 709 being etched to an etch depth of greater than or equal to 0.1 μm (e.g., greater than or equal to 0.15 μm, greater than or equal to 0.2 μm). The elimination of the seed precursor sites may result from either the reactive qualities of the reactive etchant gas or the removal of material from each of the exterior surface 707 and the interior surface 709 or a combination of both.

In embodiments, after exposure to the reactive etchant, the preform assembly 700 may be held stationary while the flow of the reactive etchant gas is stopped (e.g., via closure of the flow controller 714) and a suitable carrier gas (e.g., He) is circulated through the annular space 705 to purge the etchant. After purging, the preform assembly 700 may be held in a holding oven to purge out the carrier gas prior to application of the cladding portion preform 704 to the core portion preform 702 (e.g., during a re-draw step). As a result of the simultaneous exposure of both the exterior surface 707 and the interior surface 709 to the reactive etchant gas, seed precursor sites and other defects are eliminated, thereby providing uniform contact between the exterior surface 707 and the interior surface 709 and eliminating seed formation.

With reference to FIG. 7B, the preform assembly 718 comprises a handle assembly 724 and a nose cone 726. As depicted, a vacuum system 728 may hold the handle assembly 724, the combination of the plurality of core portion preforms 720 and the cladding portion preform 722, and the nose cone 726 together such that any gaps between interior surfaces defining the openings in the cladding portion preform 722 and the plurality of core portion preforms 720 inserted therein are sealed off from an external environment. The preform assembly 718 may be heated in a furnace to an elevated temperature, and the plurality of core portion preforms 720 and cladding portion preform 722 may be exposed to a reactive etchant gas to eliminate seed precursor sites, as disclosed above with reference to FIG. 7A. In embodiments, the plurality of core portion preforms 720 and the cladding portion preform 722 are etched prior to insertion of the plurality of core portion preforms 720 into the openings in the cladding portion preform 722. In embodiments, the structure of the handle assembly 724 and nose cone 726 are adapted to permit circulation of a reactive etchant gas through the cladding portion preform 722 when the plurality of core portion preforms 720 are inserted therein. For example, the handle assembly 724 and nose cone 726 may be fused to the ends of the cladding portion preform 722 and a reactive etchant gas source may be flowed through the handle assembly 724 and nose cone 726 while the preform assembly 718 is heated in a suitable furnace. The etching conditions and process may be similar to that described above with respect to the preform assembly 700 depicted in FIG. 7A to produce similar etching results.

With reference now to FIG. 8, a flow diagram of a method 800 of eliminating seed precursor sites at an interface between a core portion preform (e.g., a consolidated core cane comprising a doped portion doped with a halide such that the doped portion comprises at least 1.6 wt. % of the halide) and a cladding portion preform (e.g., a consolidated cladding blank, an unconsolidated silica soot body, a silica soot layer deposited directly onto the core portion preform) is shown. The method 800 may be performed at blocks 502, 504, and 506 of the method 500 described herein with respect to FIG. 5 to fabricate the core portion preform and eliminate seed precursor sites that produce gas-filled pores at the interface between the core and cladding portion preforms. The method 800 may be performed during consolidation and doping of the core portion preform to densify an exterior portion thereof. Such a densified portion may comprise a halide concentration that is less than that associated with at least a portion of the remainder of the core portion preform. For example, in embodiments, prior to drawing of the optical fiber, the densified portion of the core portion preform formed via performance of the method 800 may be free or substantially free of halide. In embodiments, the radial extent of the densified portion of the core portion preform is at least 0.10 μm (e.g., at least 0.15 μm, at least 0.20 μm). Such a densified portion may prevent dopant precursor gas from diffusing into pores formed at the interface between the core and cladding portion preforms, thereby preventing detectable defects from forming.

At block 802, a silica soot body is fabricated. Any suitable technique described herein may be used to form the silica soot body. FIG. 9 depicts an example silica soot body 900. In embodiments, for example, the OVD process described herein with respect to FIG. 3 may be used to form the silica soot body of suitable size and mass for a particular optical fiber application. The silica soot body 900 may comprise silica particles packed at a density that is greater than 0.3 g/cm³ and less than or equal to 0.6 g/cm³. At block 804, an exterior portion of the silica soot body fabricated at block 802 is densified by exposing the silica soot body to an elevated sintering temperature for one or more sintering periods and allowing the silica soot body to equilibrate between the sintering periods.

FIG. 9 depicts an example vertical tube furnace 902 that may facilitate densification of the exterior portion of the silica soot body 900. Reference will be made to various aspects of FIG. 9 in the remaining description of the method 800. As shown, the vertical tube furnace 902 comprises a plurality of heating elements 905. Each of the plurality of heating elements 905 (e.g., resistance-based heating elements, burner-based heating elements) may be controlled to create an isothermal zone 904 that is heated to a first temperature and a sintering zone 906 that is heated to a sintering temperature that is greater than the first temperature. In embodiments, the first temperature is greater than or equal to 1000° C. and the sintering temperature is greater than or equal to 1450° C., such as 1500° C. or greater.

The silica soot body 900 is mechanically connected to an actuator 910 via a handling structure 404. The actuator 910 may translate the silica soot body 900 through the vertical tube furnace 902 at a variable rate to densify only the exterior portion of the silica soot body 900. In embodiments, movement of the silica soot body 900 through the isothermal zone 904 and the sintering zone 906 is controlled such that an outermost layer of the silica soot body 900 (e.g., an outermost layer of the silica soot body 900 extending from the outer surface of the silica soot body 900 to a depth of 1 mm to 5 mm) is densified to a density of greater than 1.3 g/cm³, while any remaining portion of the silica soot body 900 is maintained at a lower density to facilitate subsequent doping thereof. An example process may be to first dry and heat the silica soot body 900 while disposed in the isothermal zone 904 by circulating He and Cl₂ gasses through the vertical tube furnace 902. After drying and heating, the silica soot body 900 may be translated by the actuator 910 at a translation rate that is greater than or equal to 25 mm/minute and less than or equal to 200 mm/minute in a downward direction along a central axis 912 of the vertical tube furnace 902 away from the isothermal zone 904. However, it should be understood that other translation rates may be used (i.e., translation rates greater than 200 mm/minute and/or less than 25 mm/minute). It should also be understood that, when relatively fast translation rates are used, multiple iterations of the translation may be performed to achieve the desired results. After an entirety of the silica soot body 900 is exposed to the elevated temperature of the sintering zone 906, the silica soot body 900 may be translated in an upward direction at a similar rate back into the cooler isothermal zone 904 and be held there for an equilibration period (e.g. of less than or equal to 30 minutes).

In embodiments, the rate at which the silica soot body 900 is translated away from the isothermal zone 904 may vary from the rate at which the silica soot body 900 is translated back toward the isothermal zone 904. That is, the heating cycle used to densify the silica soot body 900 may include different down-stroke and up-stroke velocities. In a particular example, the silica soot body 900 may be translated downward or away from the isothermal zone 904 at a lower rate than the silica soot body 900 is translated back towards the isothermal zone 904 after exposure to the sintering temperature. In embodiments, the silica soot body 900 is translated back towards the isothermal zone 904 at a rate that is at least two times greater (e.g., at least three times greater, at least four times greater) than the rate at which the silica soot body 900 is initially translated into the isothermal zone 904. Such a stroke cycle beneficially facilitates exposure of the entirety of the silica soot body 900 to the sintering temperature for a limited time period to isolate densification to the exterior portion of the silica soot body 900. Translation rates, holding times, isothermal zone temperatures, and the like may be varied to change the size of the densified portion.

The process of translating the silica soot body 900 back and forth through the sintering zone 906 may then be repeated a number of times (e.g., one time, two times, three times, four times, four times) using similar or different translation rates and equilibration times to achieve a desired densification profile. The relatively quick movement of the silica soot body 900 through the sintering zone 906 allows only the exterior portion of the silica soot body 900 to heat to enough of an extent to consolidate. The relatively low thermal conductivity of the unconsolidated silica soot of the silica soot body 900 prevents the interior portion of the silica soot body 900 from significantly densifying while in the sintering zone 906. The equilibration within the isothermal zone 904 lowers the internal temperatures of the silica soot body 900 and prevents internal densification and facilitates doping efficiency after densification of the exterior portion of the silica soot body 900. In embodiments, the density of the outermost portion of the silica soot body 900 after the block 804 is greater than or equal to 1.5 g/cm³ (e.g., greater than or equal to 1.6 g/cm³, greater than or equal to 1.7 g/cm³, greater than or equal to 1.8 g/cm³, greater than or equal to 1.9 g/cm³, or greater than or equal to 3.0 g/cm³), while a central region of the silica soot body 900 is less than or equal to 1.0 g/cm³ (e.g., less than or equal to 0.9 g/cm³, less than or equal to 0.8 g/cm³, less than or equal to 0.7 g/cm³, less than or equal to 0.6 g/cm³, or less than or equal to 0.5 g/cm³). Such a density contrast between the outermost and central regions of the silica soot body 900 aids in effectively doping the interior of the silica soot body 900 to provide the requisite refractive index contrast to achieve effective waveguiding.

Referring still to FIG. 8, at block 806, after the exterior portion of the silica soot body is densified, the interior portion (or remainder) of the silica soot body is doped via exposure thereof to a suitable dopant precursor gas. In embodiments, doping of the silica soot body may be performed within a suitable consolidation furnace, similar in structure to the consolidation furnace 400 described herein with respect to FIG. 4. In embodiments, the silica soot body is exposed to a dopant precursor gas that is SiCl₄, SiBr₄, or a combination thereof. In embodiments, the silica soot body is exposed to one or more dopant precursor gasses at a partial pressure of at least 100 kPa (e.g., at least 200 kPa, at least 300 kPa, etc.). In embodiments, a multi-zone consolidation furnace is used in the process of doping the silica soot body. The multi-zone consolidation furnace may comprise a plurality of independently controllable zones with separately controllable temperatures. The densified exterior portion of the silica soot body may raise the thermal conductivity thereof. Given such increased thermal conductivity, such independent zone temperature control may facilitate lengthwise segments of the silica soot body being exposed to elevated sintering temperatures for less time during the consolidation and doping process, thereby enabling exposure to dopants for longer periods. In an example, the multi-zone consolidation furnace comprises three independently controllable zones, as described herein with respect to FIG. 4. A sintering front may be pushed from the top of the silica soot body to the bottom of the silica soot body via temperature zone control to facilitate uniform doping despite the increased thermal conductivity caused by the densified exterior portion.

As a result of the pre-densified exterior portion of the silica soot body (before the doping of the silica soot body), the dopant precursor gasses may be prevented from diffusing into pores formed on the core portion preform. The densified exterior portion of the core portion preform may slow diffusion of the dopant gasses to a great enough extent to prevent the formation of seeds before the optical fiber preform becomes consolidated after redrawing. Thus, the pre-densification of the exterior portion of the silica soot body eliminates seed precursor sites by preventing the diffusion of the dopant precursor gases into the pores.

FIG. 10 depicts a draw assembly 1000. The draw assembly 1000 may be used to draw an optical fiber preform 1002 (e.g., comprising a core portion preform and a cladding portion preform) into an optical fiber 1004. In embodiments, the draw assembly 1000 may be used during performance of the method 500 described herein with respect to FIG. 5 after seed precursor sites for glass filled pores at an exterior surface of a core portion preform have been eliminated. The draw assembly 1000 includes a draw furnace 1006 that heats the optical fiber preform 1002 to an elevated temperature. In embodiments, the draw furnace 1006 is under a vacuum to cause consolidation of the optical fiber preform 1002 (e.g., to cause consolidation of a consolidated cladding blank onto a core portion preform). A tension assembly 1008 applies tension to the heated glass and pulls the heated glass into the optical fiber 1004 having a suitable diameter. The tension assembly 1008 may be controlled by a controller 1012 based on measurements taken by a sensor 1010 to ensure that the diameter of the optical fiber 1004 is a suitable value. A suitable coating may be applied and cured on the exterior surface of the optical fiber 1004 using a coating assembly (not depicted). After coating, the optical fiber 1004 may be wound around a storage spool 1014.

### EXAMPLES

The embodiments described herein will be further clarified by the following examples.

### Example 1

With reference to FIG. 11, a preform assembly comprising a core portion preform 1100 and a cladding portion preform 1102 was fabricated in accordance with the method described herein with respect to FIGS. 5, 6, and 7A. To fabricate the core portion preform 1100, an 8 mm silica core cane was overclad with 3800 g of soot and consolidated in 101.325 kPa SiF₄ to provide an inner cladding doped to about 2.7 wt % F (−0.8% Δ). The resulting blank was redrawn to 12 mm canes. One of the canes was selected as the core portion preform 1100 for SF₆ treatment and subsequent vacuum redraw/merge. As shown in FIG. 11, an expanded bulge 1103 was initially flameworked on the top end of the cane to allow it to hang from the handle end of the cladding portion preform 1102. Small slots were cut into the cane to ensure that gas (Cl₂, SF₆) delivered from the handle could easily flow by the support structure. The cane was etched for 15 minutes in HF to clean residue from flameworking and handling. Then the cane was cleaned with water and ethanol in a clean bench to remove particulate and organic contaminants.

To fabricate the cladding portion preform 1102, a silica overclad was constructed from a 50 mm OD×18 mm ID Hereaus tube cut to about 30 cm in length. A stem 1104, collar 1106, and handle structure 1108 were flameworked to one end of the clad portion preform to allow a 12 mm cane to be suspended into the centerline. First, the stem 1104 was fused to the cladding portion preform 1102. Next, the collar 1106 was fused to the stem 1104. The cladding portion preform 1102, stem 1104, and collar 1106 were HF etched for 15 minutes to clean any residue from flameworking and handling. The core portion preform 1100 was placed into the assembly, where the bulge 1103 rested on the stem 1104 inside the collar 1106. The handle structure 1108 was then fused inside the collar 1106 to provide the final assembly. The assembly was placed in a consolidation furnace and SF₆ gas was circulated between the core portion preform 1100 and the cladding portion preform 1102. In particular, the assembly was initially heated to an equilibration temperature of 1000° C. and then down-driven through the etch heating zone (heated to a temperature of 1430° C.) in 20% SF₆ gas entrained in flowing He at 0.55 standard liters per minute.

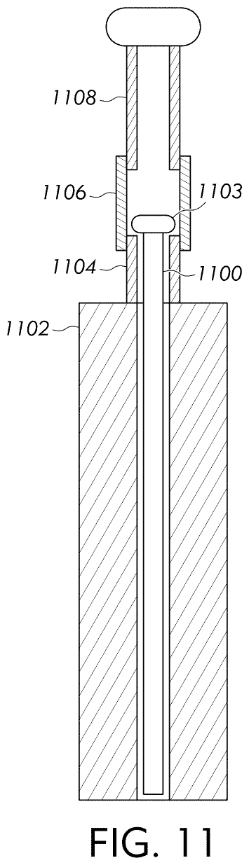

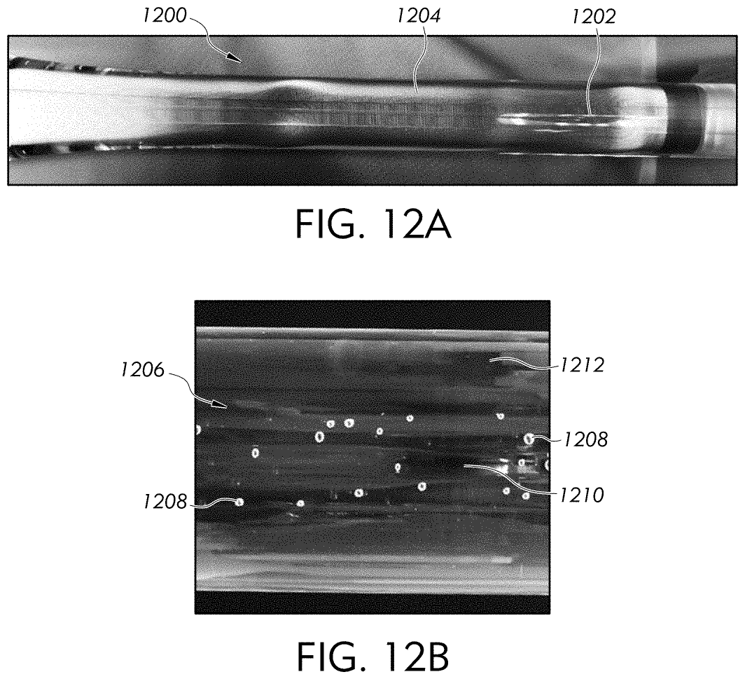

After etching, the assembly was cooled and then merged under a vacuum redraw where the glass was heated to above 1700° C. Thereafter, the assembly was drawn into fiber using conventional techniques. FIG. 12A depicts an example fiber 1200 drawn from the assembly depicted in FIG. 11. As shown, the interface between the core portion 1202 and the cladding portion 1204 of the fiber was free of observable seeds. FIG. 12B depicts a comparative example of an optical fiber 1206 of comparable composition drawn without exposure to the SF₆ gas. As shown, a plurality observable seeds 1208 are visible as a result of the diffusion of dopant gas into pores at the interface between preforms of the core portion 1212 and cladding portion 1210 of the optical fiber 1206. A visual comparison of the fibers 1200 and 1206 depicted in FIGS. 12A and 12B reveals the efficacy of the SF₆ gas exposure at eliminating observable defects in resultant fibers.

### Example 2

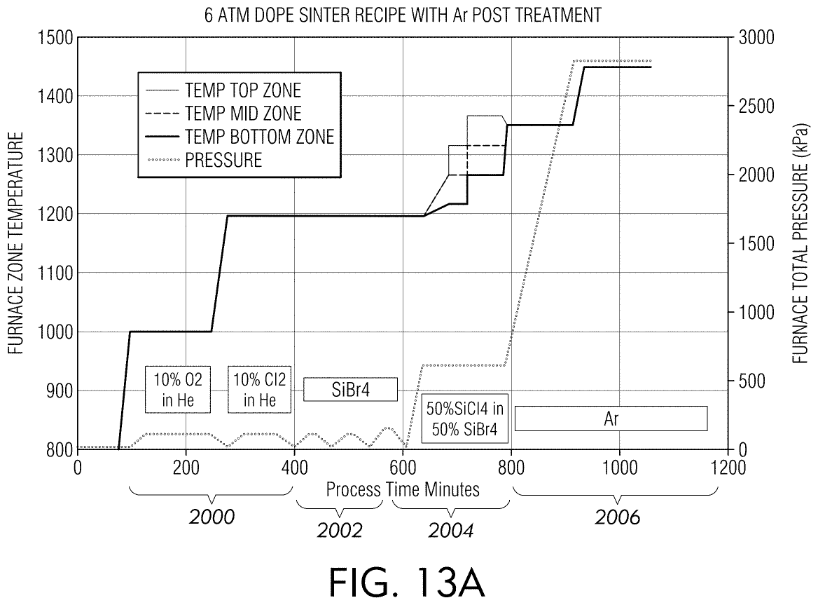

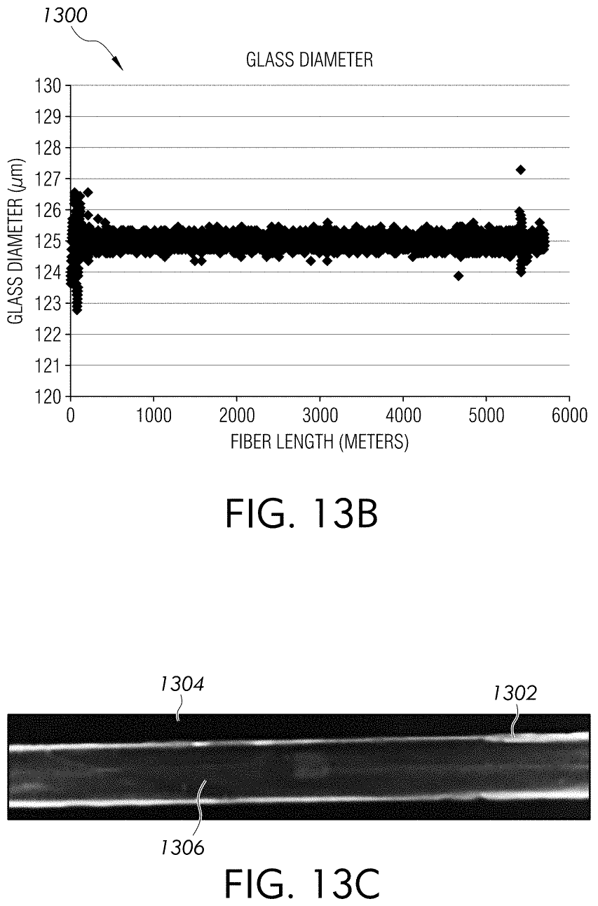

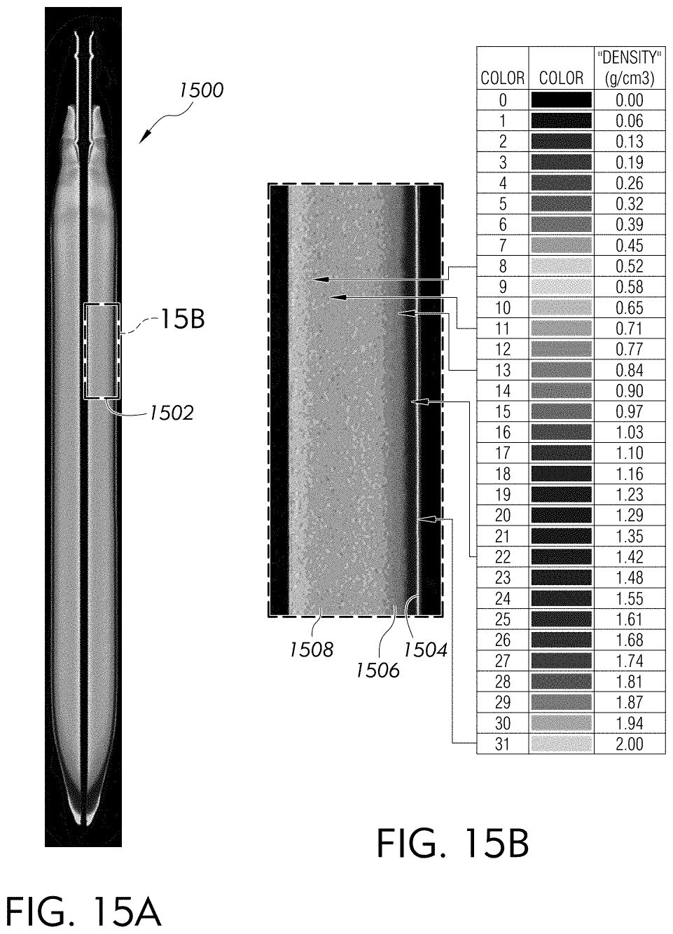

With reference to FIG. 11, a preform assembly comprising a core portion preform 1100 and a cladding portion preform 1102 was fabricated in accordance with the method described herein with respect to FIGS. 5, 6, and 7A. To fabricate the core portion preform 1100, a 2000 g silica soot preform was consolidated in a high-pressure furnace to dope the interior soot (e.g., the central region 1508 depicted in FIG. 15B) with Cl and Br to elevate the index of refraction thereof. The furnace was a three-zone furnace and the process utilized independent control of the three zones to push an axial sinter front from the top to the bottom of the silica soot body 1500. FIG. 13A graphically depicts the sintering process. During an initial period 2000, prior to doping and sintering, the silica soot body 1500 was preheated in 10% O₂ in flowing He and 10% Cl₂ in flowing He to clean and dry the soot. After a purging period 2002 where SiBr₄ was circulated through the furnace, a 1:1 ratio of SiCl₄ and SiBr₄ at a combined partial pressure of 607.95 kPa was circulated through the furnace for a doping period 2004 of approximately 7 hours. After the consolidation at 607.95 kPa was complete, the silica soot body 1500 was pressurized in an Ar atmosphere at a pressure of 2837.1 kPa for a porosity closing period 2006 of approximately 3.5 hours. While the Ar treatment was effective for closing porosity in the bulk of the glass, it also super saturated the exterior surface of the blank. To avoid Ar outgassing at interfaces of the glass, the glass surface was etched to remove the supersaturated Ar glass at the surface. In this example, the glass blank was etched in a 50% HF solution to a depth of about 500 to 600 microns to remove the Ar saturated glass surface.

To make a core portion preform 1100 suitable for assembly, the surface etched doped blank was treated as follows. First, to enable closure of the centerline of the blank, the blank was placed into a consolidation furnace with a gas line attached to the centerline. The SF₆ etch process was used to etch the centerline. In particular, the blank was placed in a consolidation furnace and SF₆ gas was circulated through the consolidation furnace. The blank was initially heated to an equilibration temperature of 1000° C. and then down-driven through the etch heating zone (heated to a temperature of 1430° C.) in 20% SF₆ gas entrained in flowing He at 0.55 standard liters per minute. Following etching, the blank was allowed to rest in a holding oven for 8 hours to allow out diffusion of the He carrier gas. The blank was then transferred to a redraw furnace, and the centerline was collapsed under vacuum as the blank was drawn to 1-meter length core canes having a diameter of about 6 mm and a relative refractive index of 0.32% delta. The result of the SF₆ etch was the formation of core canes with no seeds. To assure that the core canes were free of any dust or other contaminants the core canes were then etched in HF to a diameter of 5 to 5.5 mm. Selected canes were then flameworked to form an expanded bulge 1103 (FIG. 11) and then cleaned in HF (15 minutes) and de-ionized water and bagged.

To fabricate the cladding portion preform 1102, an 1800 g silica soot blank was consolidated. The centerline of the blank after consolidation was about 6 mm in diameter, which allowed the etched core cane to fit within the cladding portion preform 1102 such that an annular space was disposed between the surface of the etched core cane and the centerline wall. In a filtered laminar flow hood space, the core portion preform 1100 was placed into the cladding portion preform 1102 such that the expanded bulge 1103 rested in the handle structure 1108 of the sleeve. The preform assembly was subsequently inserted into a silica tube and etched in accordance with the method 600 described herein with respect to FIG. 6. In particular the assembly was placed in a consolidation furnace and SF₆ gas was circulated between the core portion preform 1100 and the cladding portion preform 1102. To facilitate etching, the assembly was initially heated to an equilibration temperature of 1000° C. and then down-driven through the etch heating zone (heated to a temperature of 1430° C.) in 20% SF₆ gas entrained in flowing He at 0.55 standard liters per minute. After etching, the etched silica tube and core portion preform were placed in a holding oven for 8 hours to diffuse out the carrier gas. The assembly was then transferred to a re-draw furnace and drawn to rods under a vacuum at a temperature of 2040° C. The rods were then drawn down to fiber.

FIG. 13B depicts a plot 1300 of fiber draw data showing a glass diameter trace of a drawn fiber. The average glass diameter was measured to be 125.0 μm. As shown in FIG. 13B, throughout an entirety of 4000 m length of the fiber (e.g., extending between approximately 500 m and 4500 m), the diameter of the fiber was between about 124.35 μm and 125.46 μm. Throughout an entirety of the drawn fiber, the standard deviation of the measured diameter was 0.23 μm. Such diameter consistency indicates the absence of seeds or diameter upsets typically caused by seed formation at the interface between the core and cladding portions of the preforms during redraw when using glass doped at high partial pressures. FIG. 13C depicts an image of a portion of an interface 1302 between a cladding portion preform 1304 and a core portion preform 1306 after being redrawn in accordance with this example. As shown, the interface 1302 is free of detectible gas-filled pores, indicating the efficacy of the SF₆ etching method described herein

### Example 3

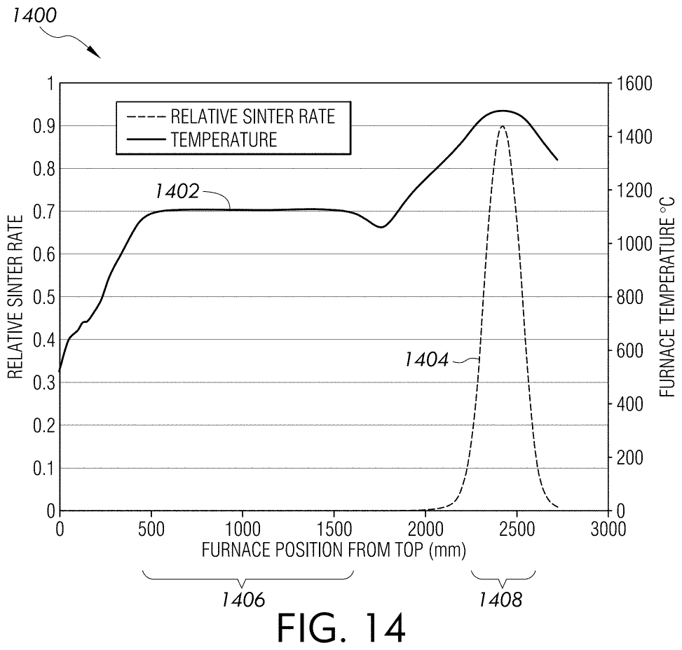

A silica soot body was fabricated using an OVD process. An outer portion thereof was consolidated using a vertical tube furnace comprising an isothermal zone at 1000° C. and a relatively short sintering zone that was 150 mm in length heated to a sintering temperature of 1400° C. The silica soot body was processed using the method 800 described herein with respect to FIG. 8. Particularly the blank was translated down through the sinter zone at a rate of 50 mm/min and then up back through the sinter zone at a rate of 200 mm/min into the isothermal zone, were it rested for 30 minutes. Such a cycle was repeated three times before removing the glazed blank from the vertical tube furnace. FIG. 14 depicts a plot 1400 of the operation of the vertical tube furnace during consolidation of the exterior portion of the silica soot body. A first trace 1402 depicts the temperature of the vertical tube furnace as a function of position within the vertical tube furnace. A second trace 1404 depicts a relative sintering rate of the soot body as a function of position. As shown, the vertical tube furnace comprised an isothermal zone 1406 heated to 1000° C. comprising a length of approximately 1.3 m. The vertical tube furnace also comprised a sintering zone 1408 heated to 1400° C. and approximately 150 mm in length. When moved downward through the sintering zone 1408 at a rate of 50 mm/min, the soot body is exposed to the sintering zone 1408 for approximately 2 minutes, and when moved back up through the sintering zone at 200 mm/min, the soot body is exposed to the sintering zone 1408 for approximately 30 seconds.

FIGS. 15A and 15B depict an x-ray computed tomography image of the silica soot body 1500 after consolidation via the procedure described above with reference to FIG. 14. FIG. 15B depicts a close-up view of the region 1502 shown in FIG. 15A. As shown, the silica soot body 1500 comprises an outermost region 1504 that is densified to greater than or equal to 2.0 g/cm³, which was backed by an inner region 1506 that is densified between 1.2 g/cm³ and 1.7 g/cm³. A central region 1508 of the silica soot body 1500 comprised a density that is less than or equal to 0.8 g/cm³ indicating that halide doping of the central region was still possible.

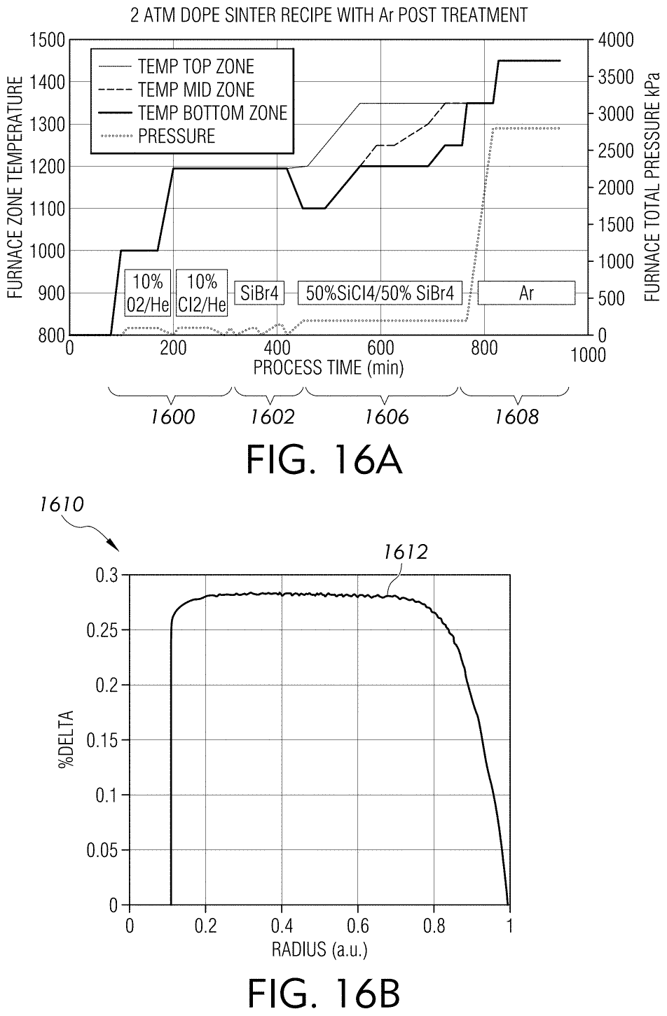

The pre-glazed silica soot body 1500 was then subjected to sintering and doping in accordance with the recipe depicted in FIG. 16A. The soot body was consolidated in a high-pressure furnace in order to dope the interior soot (e.g., the central region 1508 depicted in FIG. 15B) with Cl and Br to elevate the index of refraction thereof. The furnace was a three-zone furnace and the recipe used independent control of the three zones to push an axial sinter front from the top to the bottom of the silica soot body 1500. With reference to FIG. 16A, the following process timeline was used. During an initial period 1600, prior to doping and sintering, the silica soot body 1500 was preheated in 10% O₂ in flowing He and 10% Cl₂ in flowing He to clean and dry the soot. After a purging period 1602, where SiBr₄ was circulated through the furnace, a 1:1 ratio of SiCl₄ and SiBr₄ at a combined partial pressure of 202.65 kPa was provided into the furnace for a doping period 1606 of approximately 6 hours. After the consolidation at 202.65 kPa was complete, the silica soot body 1500 was pressurized in a 2837.1 kPa Ar for a porosity closing period 1608 of approximately 3.5 hours. While the argon treatment is effective for closing porosity in the bulk of the glass, it also super saturates the exterior surface of the blank. To avoid Ar outgassing at interfaces of the glass, it is preferred that the glass surface be etched to remove the supersaturated Ar glass at the surface. In this example, the object was to retain the full depth of the pre-glazed surface as a means of preventing interface interaction of the halide doped glass. An optimization of the glazed surface depth, post treatment time and etch depth can present a glass surface that is not supersaturated in any gas species. After consolidation, the glass appeared clear (i.e., free of observable defects).

FIG. 16B depicts a measured relative refractive index profile 1610 for the consolidated core portion preform. The relative refractive index profile 1610 included a flat high index region 1612 from the blank centerline at ˜0.1 normalized radius to 0.8 normalized radius resulting from the halide doping. The index drops gradually to that of silica at the surface. The reduced index from 0.8 normalized radius to nearly 1.0 normalized radius is a consequence of less efficient doping in the region of the silica soot body 1500 that was pre-densified. At the outer surface, the index drops to that of fused silica as a result of the pre-glazing of the soot blank. The core portion preform was redrawn into 8 mm diameter canes suitable for providing overclad layers to make a fiber preform of proper geometry. The cane surface was smooth and glossy with no evidence of seeds at or near the surface of the glass.

### Example 4

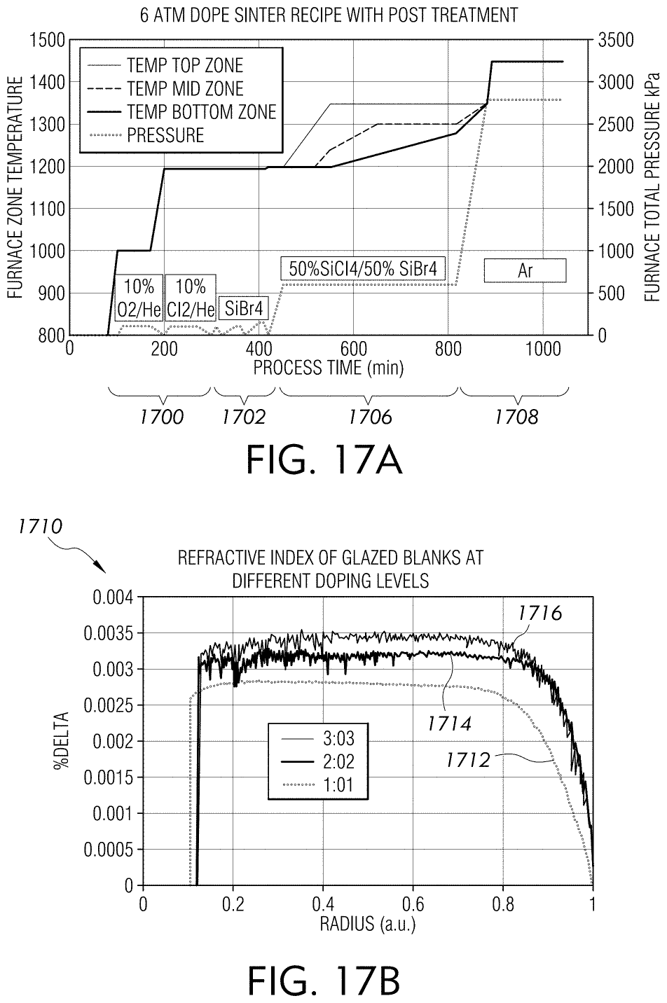

Instead of the sintering and doping recipe shown in FIG. 16A, the pre-glazed silica soot body 1500 depicted in FIGS. 15A and 15B was subjected to sintering and doping in accordance with the recipe depicted in FIG. 17A. The soot body was consolidated in a high-pressure furnace in order to dope the interior soot (e.g., the central region 1508 depicted in FIG. 15B) with Cl and Br to elevate the index of refraction thereof. The furnace is a three-zone furnace and the recipe uses independent control of the three zones to push an axial sinter front from the top to the bottom of the silica soot body 1500. With reference to FIG. 17A, the following process timeline was used. During an initial period 1700, prior to doping and sintering, the silica soot body 1500 was preheated in 10% O₂ in flowing He and 10% Cl₂ in flowing He to clean and dry the soot. After a purging period 1702 where SiBr₄ was circulated through the furnace, a 1:1 ratio of SiCl₄ and SiBr₄ at a combined partial pressure of 607.95 kPa was provided into the furnace for a doping period 1706 of approximately 7 hours. After the consolidation at 607.95 kPa is complete, the silica soot body 1500 was pressurized in a 2837.1 kPa Ar for a porosity closing period 1708 of approximately 3.5 hours. While the Argon treatment is effective for closing porosity in the bulk of the glass, it also super saturates the exterior surface of the blank. To avoid Ar outgassing at interfaces of the glass, it is preferred that the glass surface be etched to remove the supersaturated Ar glass at the surface. In this example, it was the object to retain the full depth of the pre-glazed surface as a means of preventing interface interaction of the halide doped glass. An optimization of the glazed surface depth, post treatment time and etch depth can present a glass surface that is not supersaturated in any gas species. After consolidation, the glass appeared clear.

FIG. 17B depicts a plot 1710 of three relative refractive index profiles of silica soot bodies doped using different partial pressures of SiCl₄ and SiBr₄. A first relative refractive index profile 1712 was measured for a combined dopant partial pressure of 202.65 kPa, (e.g., 101.325 kPa for each of SiCl₄ and SiBr₄). A second relative refractive index profile 1714 was measured for a combined dopant partial pressure of 405.3 kPa, (e.g., 202.65 kPa for each of SiCl₄ and SiBr₄). A third relative refractive index profile 1716 was measured for a combined dopant partial pressure of 607.95 kPa. (e.g., 303.975 kPa for each of SiCl₄ and SiBr₄). The glasses in each example showed a flat high index region from the blank centerline at ˜0.1 in normalize radius to 0.8 in normalized radius resulting from the halide doping. The index values increase from 0.28 to 0.325 to 0.35% Δ as the total doping pressure increases from 202.65 kPa to 405.3 kPa to 607.95 kPa. The index drops gradually to that of silica at the surface. The reduced index from 0.8 to nearly 1.0 in normalized radius is a consequence of less efficient doping in the region of the blank that was pre-densified. At the outer surface the index drops to that of fused silica as a result of the pre-glazing of the soot blank.

### Example 5

A silica soot body was pre-glazed in accordance with the formula depicted in FIG. 16A. A 2000 g silica soot blank was then made using a standard OVD process. The bait rod was removed to provide a 9.6 mm centerline hole. A core cane re-drawn from the silica soot body was inserted into the silica soot blank. A spot weld of the cane to the glass handle fixed the assembly and lightly fused to the handle of the blank to prevent movement during consolidation. A consolidation process comprising a dry step, and then soot blank sintering step allows the soot blank to densify onto the core cane, which provided a clean seed free interface. The blank was redrawn to 12 mm. The interface included a few very small seeds. Analysis of the seed gas with mass spectrometry showed only Ar (i.e., no SiCl₄ or SiBr₄ components). This confirms that the pre-glazed layer prevents the high-pressure core glass from generating or filling interfacial pores.

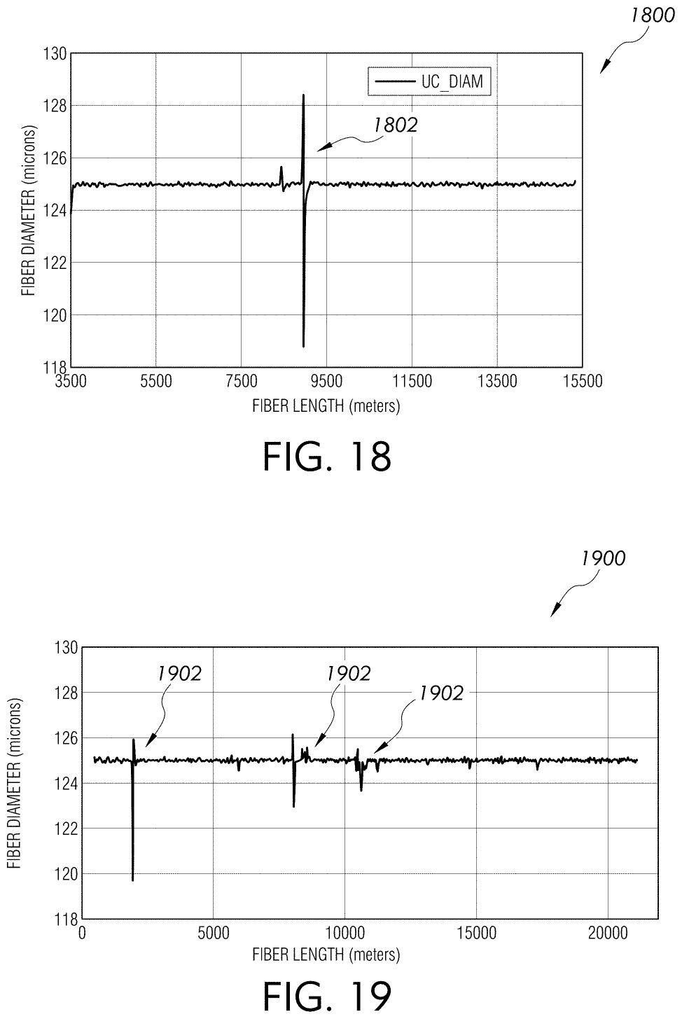

The redrawn blank was then subjected to a final overclad process, which added 1819 g of silica soot to the cane to provide a final fiber geometry. The soot blank was consolidated and the resulting glass was free of seeds. Ar filled seeds diffuse into the glass during the consolidation process and disappear. The blank was drawn to fiber. The diameter trace for the full length of fiber is provided in Table 1 below. The results are also depicted as a plot 1800 in FIG. 18.

TABLE 1

| | | | | Max | Min | |
|---|---|---|---|---|---|---|
| | Start | End | Length | Diameter | Diameter | SD |
| Segment | (mm) | (mm) | (mm) | (mm) | (mm) | (mm) |
| 1 | 3510 | 8918 | 5408 | 125.71 | 124.02 | 0.08 |
| 2 | 9020 | 15323 | 6303 | 125.14 | 124.16 | 0.06 |

As shown, one seed event 1802 was detected in over 12 km of fiber, the diameter measurements for two lengths of fiber are provided in Table 1. Diameter control was within +/−1 micron, with standard deviations <0.1 microns.

### Example 6

A silica soot body was pre-glazed in accordance with the formula depicted in FIG. 16A. A 2992 g silica soot blank was then made using a standard OVD process. The bate rod was removed to provide a 9.6 mm centerline hole. A core cane re-drawn from the silica soot body was inserted into the silica soot blank. A spot weld of the cane to the glass handle fixed the assembly and lightly fused to the handle of the blank to prevent movement during consolidation. A consolidation process comprising a dry step, a SiF₄ doping step and then a soot blank sintering step in SiF₄ allows the soot blank to densify onto the core cane, providing a clean seed free interface. The presence of SiF₄ doped the clad to a refractive index −0.2% delta lower than fused silica. The interface included a few very small seeds. Analysis of the seed gas with mass spectrometry showed only Ar (i.e. no SiCl₄ or SiBr₄ components). This confirms that the pre-glazed layer prevents the high-pressure core glass from generating or filling interfacial pores. The blank was redrawn to 12 mm. The interface included a few very small seeds. Analysis of the seed gas with mass spectrometry showed only Ar (i.e. no SiCl₄ or SiBr₄ components). This also confirms that the pre-glazed layer prevents the high-pressure core glass from generating or filling interfacial pores

The redrawn blank was then subjected to a final overclad process. The soot blank was consolidated and the resulting glass was free of seeds. The blank was drawn to fiber. The diameter trace for the full length of fiber is provided in table 2 below. The results are also depicted as a plot 1900 in FIG. 19.

TABLE 2

| | | | | Max | Min | |
|---|---|---|---|---|---|---|
| | Start | End | Length | Diameter | Diameter | SD |
| Segment | (mm) | (mm) | (mm) | (mm) | (mm) | (mm) |
| 1 | 482 | 1958 | 1476 | 125.19 | 124.85 | 0.06 |
| 2 | 1971 | 8052 | 6081 | 125.24 | 124.52 | 0.07 |
| 3 | 11324 | 21065 | 9741 | 124.17 | 124.56 | 0.06 |

As shown, three seeds 1902 were detected. Diameter statistics for three lengths of fiber are provide in Table 2. The diameter stability is very good over lengths of 6 and 10 km.

In view of the foregoing description, it should be understood that methods of forming optical fibers comprising doped portions including 1.6 wt. % of a halide dopant with relatively constant diameters have been shown and described. The methods described herein aid in reducing the probability that dopant precursor gasses trapped in consolidated core portion preforms diffuse into pores at interfaces between the core portion preforms and cladding portion preforms of the optical fibers being fabricated. The methods described herein may include exposing the core and cladding portion preforms to a reactive etchant to eliminate the presence of pores at the interface. The methods described herein may also include densifying an exterior portion of a silica soot body of the core portion preform prior to doping to create an outer layer with a reduced dopant concentration that prevents diffusion of the dopant precursor gasses. The methods described herein facilitate production of commercially viable lengths (e.g., greater than or equal to 2.0 km, greater than or equal to 5.0 km, greater than or equal to 9.0 km) optical fibers that are heavily doped halides. As such, the methods of the present disclosure may facilitate production of high-pressure Cl/Br-doped optical fibers to facilitate the production of low loss optical fibers while reducing the need to dope cladding with fluorine. The methods of the present disclosure may also facilitate the production of reduced clad, hydrogen resistant, and low bend-loss multi-core optical fibers having relatively high core densities.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of fabricating an optical fiber, the method comprising:
providing a core portion comprising a doped portion comprising greater than or equal to 1.6 wt. % of a halide dopant;
eliminating seed precursor sites at an exterior surface of the core portion, the seed precursor sites forming seeds in the optical fiber, wherein the eliminating the seed precursor sites comprises one or more of:
(i) fabricating the core portion by densifying an exterior portion of a silica soot body prior to exposing the silica soot body to the halide dopant, and
(ii) exposing the exterior surface of the core portion to a reactive etchant;
forming an optical fiber preform by applying cladding material to the exterior surface of the core portion; and
drawing the fiber preform into the optical fiber.

2. The method of claim 1, wherein the seeds are gas-filled pores in the optical fiber.

3. The method of claim 1, wherein the gas-filled pores comprises pores filled with the halide dopant.

4. The method of claim 1, wherein the optical fiber is free of seeds having a largest dimension of 10 μm or greater.

5. The method of claim 4, wherein the optical fiber is free of seeds having a largest dimension of 1 μm or greater.

6. The method of claim 1, wherein:
the optical fiber comprises a length of at least 2 km, and
an outer diameter of the optical fiber varies by no more than 2% throughout an entirety of the length.

7. The method of claim 1, wherein:
the eliminating the seed precursor sites comprises exposing the exterior surface of the core portion to the reactive etchant,
the method further comprises, prior to eliminating the seed precursor sites, inserting the core portion into an opening of a consolidated cladding blank of cladding material, and
the eliminating the seed precursor sites comprises flowing the reactive etchant into a space extending between the core portion and the consolidated cladding blank.

8. The method of claim 7, wherein, during the eliminating the seed precursor sites, the core portion is etched to a depth of greater than or equal to 0.2 μm.

9. The method of claim 1, wherein:
the eliminating the seed precursor sites comprises exposing the exterior surface of the core portion to the reactive etchant,
the reactive etchant comprises a reactive etchant gas, and
the exposing the exterior surface of the core portion to the reactive etchant occurs while the core portion is heated to a temperature of greater than or equal to 1300° C. and less than or equal to 1500° C.

10. The method of claim 9, wherein the exterior surface of the core portion is exposed to the reactive etchant gas for a period of greater than or equal to 5 minutes.

11. The method of claim 10, wherein:
the eliminating the seed precursor sites comprises exposing the exterior surface of the core portion to the reactive etchant gas,
the core portion comprises a core and an inner cladding,
and the doped portion of the core portion comprises the inner cladding, and
the halide dopant comprises fluorine.

12. The method of claim 1, wherein:
the optical fiber comprises a multi-core optical fiber,
providing the core portion comprises providing a plurality of core portions, each of the core portions comprising a core and an inner cladding doped with fluorine,
the method further comprises inserting the plurality of core portions into a consolidated cladding blank, and
the elimination of the seed precursor sites comprises exposing the plurality of core portions and the consolidated cladding blank to the reactive etchant prior to the insertion of the plurality of core portions into the consolidated cladding blank.

13. The method of claim 1, wherein the eliminating the seed precursor sites comprises fabricating the core portion by densifying the exterior portion of the silica soot body by exposing the silica soot body to temperature of 1450° C. or greater.

14. The method of claim 13, wherein the densified exterior portion of the silica soot body comprises a radial width of at least 0.15 μm.

15. The method of claim 13, wherein forming the optical fiber preform comprises:
forming a second silica soot body directly on the exterior portion, and
consolidating the second silica soot body to form a cladding layer on the exterior portion.

16. The method of claim 13, wherein forming the optical fiber preform comprises:
inserting the core portion into a soot blank;
consolidating the soot blank; and
drawing or redrawing the consolidated soot blank and the core portion into the optical fiber preform.

17. The method of claim 1, wherein the halide dopant comprises chlorine, bromine, or both.

18. The method of claim 1, further comprising forming the core portion by exposing a soot body to a gas phase halogen doping precursor at a partial pressure of greater than or equal to 100 kPa.

19. A method of fabricating an optical fiber, the method comprising:
fabricating a core portion from a silica soot body, wherein the fabricating the core portion comprises:
exposing the silica soot body to a doping precursor comprising a halide; and
sintering the silica soot body to form the core portion, wherein the exposure of the silica soot body to the doping precursor results in the core portion comprising greater than or equal to 1.6 wt. % of the halide;
forming an optical fiber preform by applying cladding material to an exterior surface of the core portion; and
drawing the optical fiber preform into an optical fiber, wherein, after the drawing, an interface between the cladding material and the core portion is free of gas-filled pores that are filled with the halide and that have a largest dimension greater than or equal to 10 μm.

20. The method of claim 19, wherein:
the applying the cladding material comprises inserting the core portion into an opening of a consolidated cladding blank of the cladding material, and
the method further comprises exposing the exterior surface of the core portion to a reactive etchant gas, wherein the reactive etchant gas is provided into an annular space between the consolidated cladding bank and the core portion for at least 5 minutes.
